(19) United States
(12) Patent Application Publication
(10) Pub. No.: US 2009/0147772 A1
(43) Pub. Date: Jun. 11, 2009

(54) SYSTEMS AND METHODS FOR PROVIDING PRESENCE INFORMATION IN COMMUNICATION

(76) Inventors: Prasad Rao, Bangalore (IN); Srinivasa Athuluru, San Francisco, CA (US); Varad Sheshadri, Bangalore (IN); Ajay Mitttal, Pune (IN); Chintan Shah, Bangalore (IN); Ruchir Vasavada, Bangalore (IN); Amit Shukla, Bangalore (IN); Marc Solsona-Palomar, San Jose, CA (US)

Correspondence Address: IPSG, P.C., P.O. BOX 700640, SAN JOSE, CA, 95170, US

(21) Appl. No.: 12/268,613

(22) Filed: Nov. 11, 2008

Related U.S. Application Data
(63) Continuation-in-part of application No. 11/538,034, filed on Oct. 2, 2006.

(51) Int. Cl. H04L 12/66

(52) U.S. Cl. 370/352

(57) ABSTRACT

A method for facilitating communication between at least a first user who uses a first device and a second user who uses a second device. The method may include associating possible device states with possible presence states. The possible device states pertain to the first device, and the possible presence states pertain to the first user. The method may also include determining a device state of the first device. The method may also include setting a communication presence state of the first user to be a first presence state if the device state is a first device state and setting the communication presence state of the first user to be a second presence state if the device state is a second device state. The method may also include providing information concerning the communication presence state of the first user to at least the second device.

### CROSS-REFERENCE TO RELATED APPLICATIONS/PRIORITY CLAIM

This application is a continuation-in-part application under 37 CFR 1.53(b) of and claims the benefit under 35 U.S.C. 120 of a commonly assigned utility patent application entitled “RENDEZVOUS CALLING SYSTEMS AND METHODS THEREFOR,” by Palakkal et al., Attorney Docket Number DVTS-P002, application Ser. No. 11/538,034 filed on Oct. 2, 2006, which is incorporated herein by reference.

### BACKGROUND OF THE INVENTION

Conventional mobile communication platforms include cellular communications, for example, Global Systems for Mobile (GSM) communications. Other conventional platforms that support limited mobility include Wi-Fi, which is based on IEEE 802.11 standards. These are both well known and established platforms.

Next generation platforms are designed to permit mobile users to move between cellular and Wi-Fi networks and include an Unlicensed Mobile Access (UMA) standard that provides a switch controller for carriers to permit users to transcend between cellular and Wi-Fi networks and vice-versa. However, the UMA standard has disadvantages including that the carrier controls the calls and decides if and when to switch users between networks.

What is needed is an advanced mobile communication platform that provides enterprise level communication and control over users and the networks that they choose to select based on enterprise driven criteria rather than carrier driven criteria.

### SUMMARY

An embodiment of the present invention relates to a method for facilitating communication between at least a first user who uses a first device and a second user who uses a second device. The method may include associating possible device states with possible presence states. The possible device states pertain to the first device, and the possible presence states pertain to the first user. The method may also include determining a device state of the first device. The method may also include setting a communication presence state of the first user to be a first presence state if the device state is a first device state, the first presence state being one of the possible presence states, the first device state being one of the possible device states. The method may also include setting the communication presence state of the first user to be a second presence state if the device state is a second device state, the second presence state being another one of the possible presence states, the second device state being another one of the possible device states. The method may also include providing information concerning the communication presence state of the first user to at least the second device.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The invention is described with reference to the following figures.

FIG. 1 depicts a system network according to an embodiment of the invention.

FIGS. 2A-C depict a mobility server according to an embodiment of the invention.

FIG. 3 depicts a mobility client according to an embodiment of the invention.

FIG. 4A depicts an overview of the rendezvous calling (RC) architecture.

FIG. 4B depicts message exchanges between the RS Client and the RC capable Media Communication Server.

FIG. 4C is a flowchart showing logic employed in the Media Communication Server for RC processing.

FIG. 5A depicts a system block diagram purposes of describing a network stack according to an embodiment of the invention.

FIG. 5B depicts a system network stack according to an embodiment of the invention.

FIG. 6 depicts an overview of the secure VoIP deployment for enterprise communication.

FIG. 7 shows, in an embodiment of the invention, a telecommunication session being established between an external telecommunication device and a mobility client, which is within an enterprise.

FIG. 8 illustrates, in accordance with one or more embodiments of the present invention, examples of server functional modules that may be implemented in a mobility server.

FIG. 9 illustrates, in accordance with one or more embodiments of the present invention, examples of client functional modules that may be part of mobility client application.

FIG. 10 illustrates, in accordance with an embodiment of the invention, a high level logic block diagram of an automated rendezvous calling environment.

FIG. 11 shows, in accordance with an embodiment, the steps taken by a RC (rendezvous calling) server module in setting up a RC call.

FIG. 12 shows, in accordance with an embodiment, a simple call flow involving two teleconference participants.

FIG. 13 shows, in accordance with an embodiment of the present invention, the call flow for setting up the teleconference using the parameters specified in the example of FIG. 12, except that the mobility server is now shown to include as constituent components presence server, call control, and RC server.

FIG. 14 shows a schematic diagram illustrating a communication system including a mobility server and client devices (hereinafter interchangeably “client devices,” “clients,” or “devices”) for providing communication services including user presence information features in accordance with one or more embodiments of the present invention.

FIG. 15 shows a flowchart illustrating a method for routing communication traffic based on presence state settings in accordance with one or more embodiments of the present invention.

FIG. 16A shows a flowchart illustrating a method for providing user presence state information and/or presence messages based on client device state information in accordance with one or more embodiments of the present invention.

FIG. 16B shows a schematic diagram illustrating the presence message of a user seen by the user's contacts when the user is at work in accordance with one or more embodiments of the present invention.

FIG. 16C shows a schematic diagram illustrating the presence message of a user seen by the user's contacts when the user is at home in accordance with one or more embodiments of the present invention.

FIG. 17 shows a flowchart illustrating a method for adding a user to a contact list in accordance with one or more embodiments of the present invention.

FIG. 18 shows a flowchart illustrating a method for optimizing network resource utilization in providing presence information in accordance with one or more embodiments of the present invention.

### TABLE OF CONTENTS

A. Architecture

B. Automatically Setup of Point-To-Point and Point-To-Multipoint Multi-Media Conference Calls with Administrator and User Controlled Rules and Preferences (Rendezvous Calling)

C. Providing Presence Information In Communication

D. Conclusion

### DETAILED DESCRIPTION

The invention is described with reference to specific apparatus and embodiments. Those skilled in the art will recognize that the description is for illustration and to provide the best mode of practicing the invention. For example, while references are made to certain communication protocols, others are anticipated by the invention. For instance, while Wi-Fi (IEEE 802.11) is described as a protocol for wireless communication, other protocols may be implemented in the invention. References made herein to the mobility client, client device, and mobile equipment (ME) are equivalent.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

### A. ARCHITECTURE

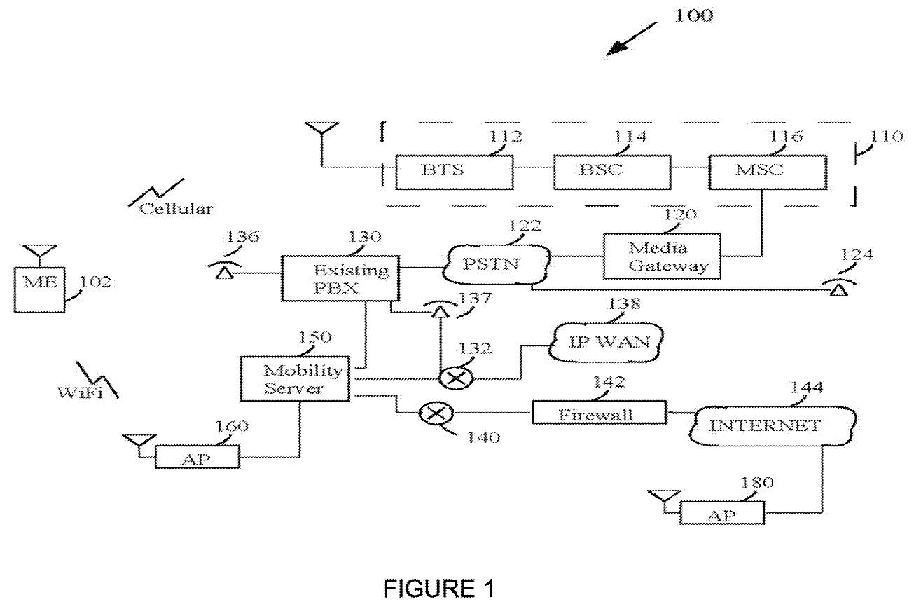

FIG. 1 depicts a system network 100 according to an embodiment of the invention. Mobile equipment (ME) 102 is provided that communicates with the network in a number of possible ways. ME 102 can communicate with a cellular network 110 that includes a Base Transceiver Station (BTS) 112, a BTS Switching Center (BSC) 114 and Mobile Switching Center (MSC) 116. The MSC is coupled to a Media Gateway 120 that is coupled to a public switched telephone network (PSTN) 122. Other conventional public and private telephones 124 are also coupled to the PSTN. A PBX 130 is coupled to the PSTN and serves an enterprise for purposes of making and receiving calls, for example, via telephone 136. Mobility server 150 is coupled to the PBX as well as other networks. For example, mobility server 150 is coupled via router 132 to an Internet Protocol Wide Area Network (WAN) 138. The mobility server 150 is also coupled via router 140 and firewall 142 to the Internet 144. The mobility server is also coupled to a local area network (LAN) with wireless access point 160. One access point is depicted while the invention anticipates multiple access points as well. The access point 160 permits a user with ME 102 to wander in the enterprise and stay connected to the PSTN through the mobility server 150 and PBX 130. If the user wanders beyond the boundary of the LAN, the user will be connected to an alternate network (e.g. the cellular network) as described below in detail. Also depicted is an access point 180 that is coupled to the internet for access under certain conditions as described herein.

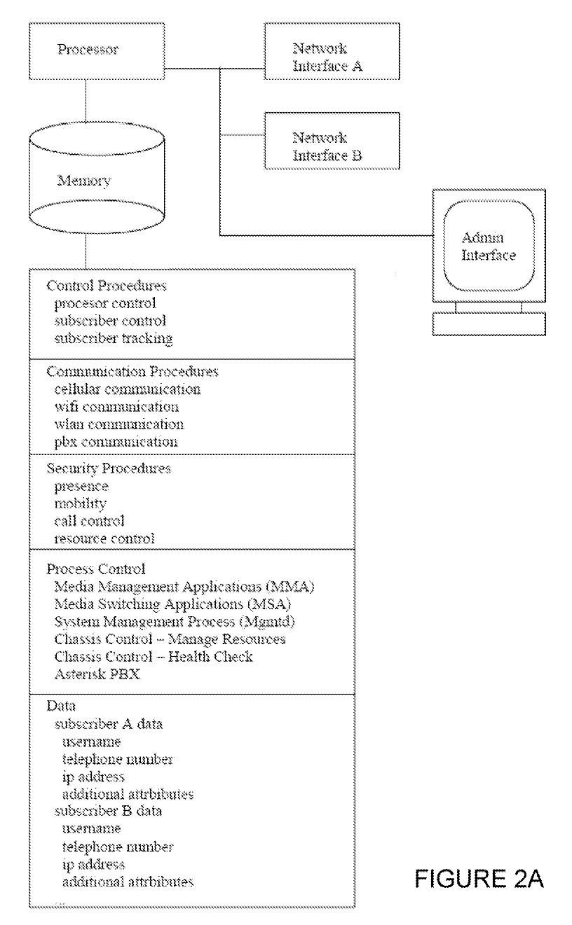

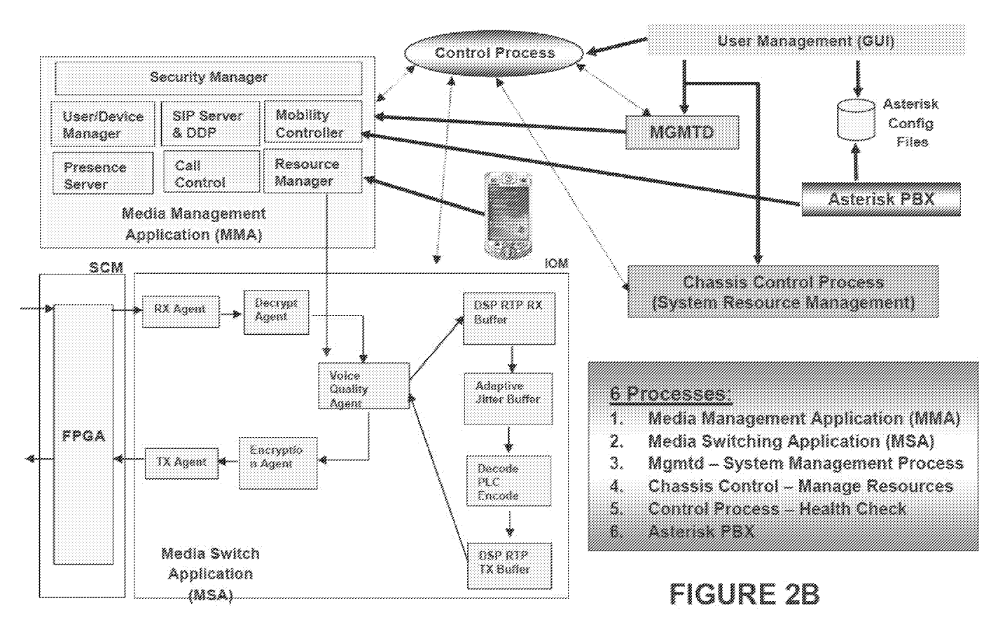

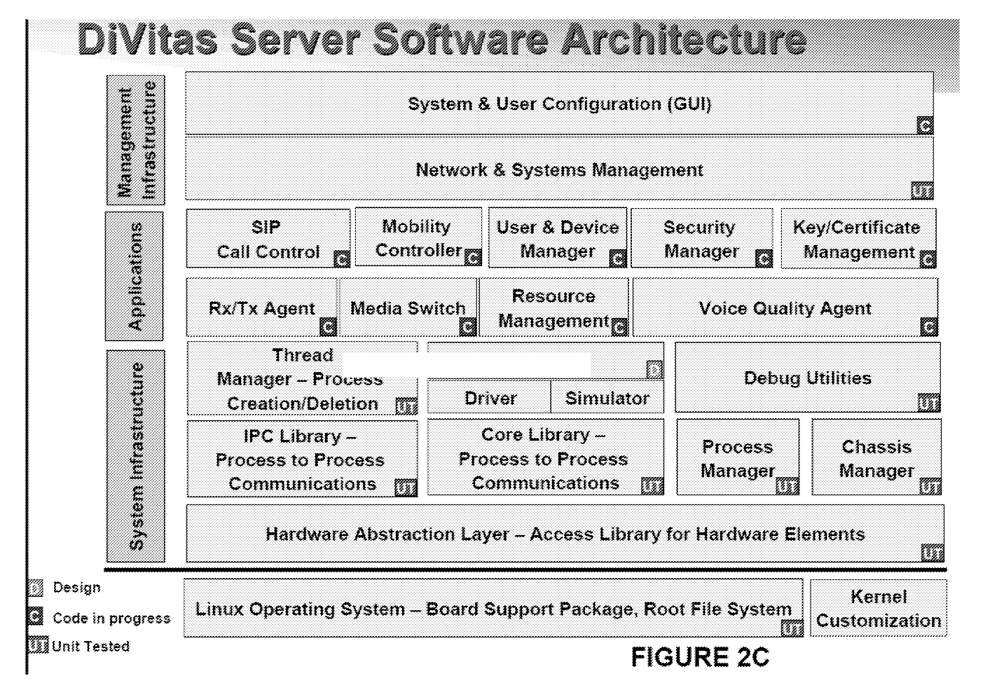

FIG. 2A-C depict a mobility server according to an embodiment of the invention.

Security Manager—The definition of security when two or more entities are communicating involves the following aspects:

1. Mutual Authentication of the communicating entities

2. Privacy of the communication channel

3. Integrity of messages exchanged

4. Authentication of messages

In mobility solution in accordance with one or more embodiments of the present invention, there are three distinct communicating entities: mobility client, mobility server and external VoIP GW. And there are two distinct types of paths between these entities: SIP signaling path and Media path.

As described in the Architecture Specification[1] the following mechanisms are used to achieve the above mentioned security aspects between client, server and external gateway for signaling and data paths:

1. SIP TLS session between client and server.

2. Client Authentication using SIP Notify after SIP TLS establishment

3. Authentication of users with server

4. SIP TLS session between server and external VoIP Gateway.

5. Server authentication with external VoIP Gateway

6. Secure media path

7. Derived requirements

User/Device Manager/Mobility Controller—The device and mobility Manager (hereby referred to as DMM) is a module that handles device configuration and status as well as the mobility aspects while there is an active call on a device. The following sections capture the functional and design specifications of the DMM along with the public interfaces that it supports.

Here is a summary of the roles and responsibilities of the DMM

1. Device configuration controlled by the enterprise administrator.

2. Report status of the device.

3. Image management for the device

4. Maintain and implement the mobility logic for handsets with an active call—i.e. handle Wi-Fi to Cell and vice-versa handoff.

5. Handles device initialization and configuration requests from the client.

Control Plane/Call Control—Call control (CC) is the primary control plane module responsible for the following functions:

1. Voice over IP call processing

2. SIP proxy server and B2BUA

3. PSTN Call management through PSTN GWs

4. PBX feature management through Asterisk

5. Resource and Connection management

Call control module resides on the DN media switch. It interfaces with the SIP stack and Asterisk (or any other) PBX module to provide the above mentioned functionality.

1. SIP stack (for UA, CCM, and Asterisk etc): SIP stack is mainly used as protocol message decode/encode engine. SIP stack also performs basic protocol specific tasks, like standards based message parsing and validation, retransmissions, proprietary message validation etc. For most of the proxy and B2BUA tasks, SIP stack relies on CC for decision making. Interactions between CC and Asterisk as well as CC and CCM are through standards based SIP messages.

2. Proxy Agent/Configuration Manager (PA/CM): Proxy agent acts as a configuration manager for all the applications. Call control related information is downloaded by PA at the time of provisioning or after the disk DB is read following a system bring up. CC stores the data in RAM for local/faster access. CC also updates PA of any dynamic information (e.g. call going active or down), or on demand information (e.g. SNMP GET)

3. Resource Manager (RM): Resource manager provides logical map of the physical/network resources. These resources include GE port, DSP resources, sockets, UDP/TCP ports etc and do not include system resources like memory, buffer pool, timers, queues etc. It also does not include sockets used for internal IPC communication. CC uses RM for resource CAC, resource reservation and commit. As part of the commit, RM talks to media switch to program hardware to enable media flow.

Media Switch Application (MSA)—The MSA will be designed to run partially on Linux and remaining on TMS320DM64x DSP processor. The application will perform the following functions:

RTP packet processing.

Switching.

Transcoding.

Conferencing.

Adaptive jitter buffer.

Packet loss concealment.

Post processing which includes VAD/CNG and AGC

The MSA software needs to support encoding/decoding of different speech codecs. The type of algorithm and channel can change during run time i.e. a design to support multi-channel, multi-algorithm is needed. Each codec algorithm needs to be reentrant, and the program as well as data needs to be fully releasable. In order to support various codecs the following needs to taken into account:
a. Since the DSP has limited on chip data memory not all data can be placed on-chip all the time in multi-channel, multi-algorithm application. This requires all data (context and tables) in each algorithm to be relocatable (between on/off chip memory) during context switching. This requires a need to find out the memory, stack size as well as MIPS requirement for each supported codec.
b. A mechanism to exchange messaging between host and DSP process indicating channel number as well as codec type along with any other features. The channel configuration manager needs to open a channel on DSP indicating type of functionality required. Periodic message indicating the state of DSP needs to be implemented.

The DSP processor allows the external host to access the DSP external memory. The DSP has 16 Kbytes of first level program as well as data memory. The program as well as data memory share the second level memory of 256 Kbytes. The 16 Mbytes of external memory (SDRAM) is available. The shared memory between the two processors stores the incoming as well as outgoing RTP data. Since the DSP needs to support N number of channels, this memory will contain N receive as well as transmit buffers of length 320 bytes each (for video these buffers need to be of 1500 bytes). Data structure for messaging between host and DSP as well as information needed on per call basis needs to be defined. The following steps define the DSP functionality:
a. At boot up once the software is downloaded to DSP (the DSP will indicate the same by writing a predetermined value at a fixed memory location to indicate to host that the software is downloaded).
b. Upon successful download of software, the DSP will run an internal timer of 10 msec.
   At this time the DSP is polling for channel state to change to process which is set by the host once the packet arrives.
c. A start call or open channel command from the host indicating codec type, data ready as well as call type (initially only voice) is sent for RX as well as TX direction.
d. Based on channel opened the DSP picks up the RTP data from the external buffers and performs the DSP related functionality on those.
e. On the TX side the DSP places encoded data on the external buffers to be picked up by the TX agent.

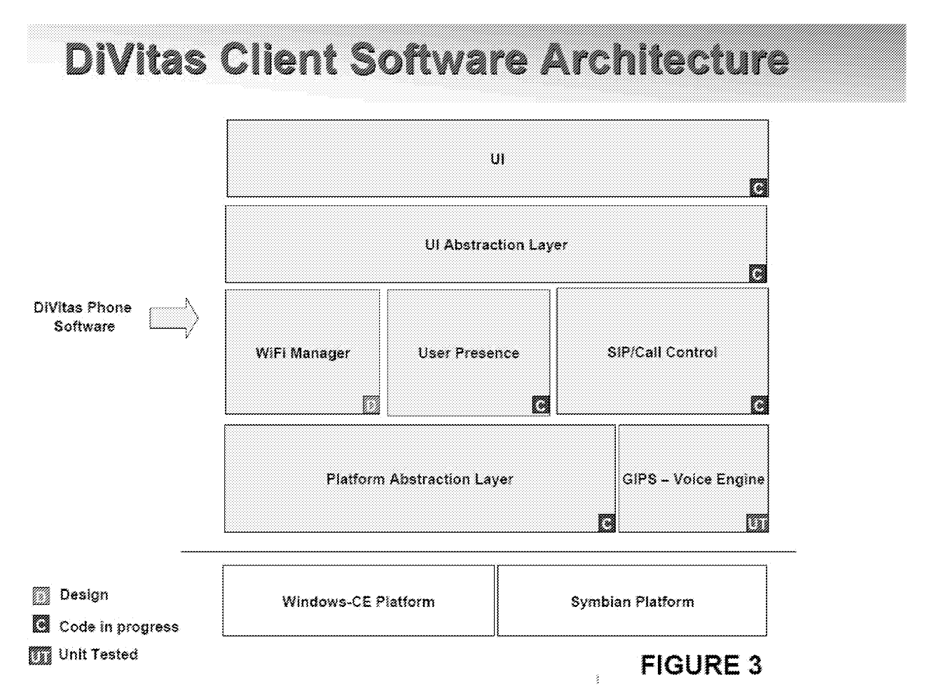

FIG. 3 depicts a mobile equipment client according to an embodiment of the Invention.

The client software or handset software runs on the handsets that are compatible with the mobility server. Typically these are dual-mode handsets that have the capability to provide telephony connection on the cellular network (CDMA or GSM) as well as IP connection on the LAN network (wired LAN or wireless LAN).

The software can be also be compiled for a desktops/laptops or a PDAs which have a microphone and a speaker to function as a softphone.

User Interface

The client user-interface provides the following functionality:
Setup startup configuration—DNS IP addresses, mobility server URL, Startup user-state (INVISIBLE/AVAILABLE), security settings
Change user state (INVISIBLE/AVAILABLE)
Add enterprise “buddies” and get their presence information (INVISIBLE/AVAILABLE/CALL-IN-PROGRESS)
Display availability status of enterprise “buddies” and connect to them
User Interface to common enterprise telephony features
   call making
   call receiving
   call waiting
   call forwarding
   call transfer
   multi-party conferencing
   voice-mail notification
   missed calls notification
   received calls notification
   placed calls notification
   number lookup and dial by name
Manual override to use cellular network instead or Wi-Fi network
Display version mismatch
Upgrade request/status
Disable/inhibit client software—ISP application is used to make/receive cellular calls Call-control and voice
Call control for making VoIP calls on LAN interface
Voice Engine for making VoIP calls on LAN interface—includes codecs, echo-cancellation, jitter control, error concealment
Call handoff from cellular call to VoIP call
Call handoff from VoIP call to cellular call 802.11
Determine which IP networks are available and their signal strength and communicate that information to the server
AP client
Power management of 802.11 miniport—whenever the signal strength of 802.11 is below acceptable threshold, hibernate and poll it at infrequent intervals to conserver power
Package the signal strength and voice-quality info into RTCP packets if the call is in progress or in keepalives if the call is not in progress to communicate to the server. Whenever the signal strength drops below an acceptable threshold or the voice-quality deteriorates, the server will make a decision to switch the calls from VoIP to cellular network.

Platforms

Since there are a multitude of handset vendors in the market and a lot of them coming up with dual-mode handsets, it is a must to design the software in such a way that most of the code is shared across handsets. Therefore, the code has to be divided into platform dependent part and platform independent part. Most, in fact all of the Divitas core value should be in platform independent pair of the software which should be easily portable from one platform to another. The platform dependent part should be only the functional adaptation layers (particularly Telephony, LAN, 802.11, Audio and Display adaptation layers). Whenever the code is ported to a new platform, only these adaptation layers need to be modified or rewritten, while providing a uniform API to the platform independent part.

The client software will run on multiple handset platforms. The most prevalent handset platforms are Windows® CE, Linux®, and Symbian®.

In addition to the dual-mode handsets, the client application is designed to work on 802.11 phones, PDAs or laptops/desktops which do not have a cellular telephony interface. On these platforms, a subset of features is available to the user. Basically, the call handoff from VoIP to cellular will not be possible.

Theory of Operations

Startup and Security Operations

On startup, the client application looks for the available resources on the handset. It first checks for presence of wired network. If not present, then it checks for the presence of an 802.11 network. The wired or wireless medium authentication is done depending on the enterprise security policy. The handset client shall support the security mechanism employed in the enterprise. The most common security mechanism is WPA (Wi-Fi Protected Access). Once the authentication is done successfully, the wireless client gets the IP address for the IP interface using DHCP.

The application gets the mobility server URL and DNS IP addresses from persistent database and tries to register with a mobility server.

The client application could be running on a handset which is inside the enterprise network. In that case, the client can reach the mobility server without any other security blankets. In case the client is in a public network, say a coffee shop or an airport with Wi-Fi internet access, typically the user sets up a VPN connection to the enterprise. The client can reach the mobility server only after the VPN tunnel is setup.

The client application software authenticates the handset with the server by sending an encrypted certificate (installed by Enterprise IT) to the server. Once that is authenticated, the client gets the login/password from the user or stored in the handset, encrypts that and sends it to the server for user authentication. On successful authentication, the server replies by sending the enterprise phone number. In reply, the client sends the cellular phone number to the server. The server binds the two for all future handoff scenarios.

The signaling and media stream are secured using SIP/TLS for signaling and SRTP for media stream. However, if the user is on a VPN link, then client need not add another level of encryption. Adding another level of encryption to that may result in reduced voice quality. In that case, SIP is used for signaling and RTP/RTCP for media stream.

The above process is repeated whenever the client regains network connectivity with the server.

Steady State Operations

The user can choose to be INVISIBLE or AVAILABLE at startup by configuring on the GUI and saving that configuration in the persistent database. The client updates the user's presence information to the server.

The user can also enter frequently called buddies within the enterprise and save that configuration in the persistent database on the handset. The client gets the presence information (in bulk) of these buddies whether they are INVISIBLE, AVAILABLE or CALL-IN-PROGRESS. The server updates the presence information of these buddies to the clients as and when the event occurs.

Whenever a call is not in progress, the client and server exchange keepalives periodically.

The client sends the network status to the server periodically. If it is on an 802.11 wireless network, it sends the SSID, signal-strength and bandwidth of the associated access point (AP) to the server. If there is a call in progress, it sends it as part of in-band RTCP packets. If there is no call in progress, it sends it in out-of-band keepalive messages.

Whenever a network session is available from the client to the server, the preferred mode of making and receiving calls to the client is on the network interface. However, the user can choose to override it and make the outgoing calls on the cellular network. This selection is not communicated to the server and it doesn't affect the incoming calls. This selection is also not stored in persistent database. The user has to explicitly make the selection every time he makes an outgoing call.

Whenever a network session is not available from the client to the server, the only way of making and receiving calls is on the cellular interface. The user does not have access to all the enterprise features. The user can make and receive calls using the client software Ut however the client software provides only a subset of the service provider features. To use all the features of the cellular service provider network, the user may have to terminate (or inhibit) the client software and use the cellular service providers dialer application. If the service provider application is being used to make and receive calls, then the handoff described below in section 3.4.2 will not be possible.

A user has access to all the enterprise features as long as the client has a session established to the server. The client GUI is used to provide access to these enterprise features to the user.

Voice

SIP signaling is used to establish voice calls between the client and the server. Voice from the audio receiver is encoded into one of the codecs supported by Voice Engine (VE), encapsulated into RTP packets, encrypted if needed, and sent on the IP interface to the server. Similarly RTP packets received from server is decrypted if needed, decoded using one of the codecs and played out. Speech decoding, jitter control and error concealment are done by VE on the receive side.

In addition to encryption/decryption, encoding/decoding of speech, Voice Engine performs error concealment, jitter control, adaptive packet buffering, Acoustic Echo Cancellation and Suppression, Noise Cancellation and Suppression, Automatic Gain Control, Voice Activity Detection, Comfort Noise Generation.

Roaming

A handset client is a mobile device, unlike the portable laptops.

Intra-WLAN Handoff

When a user is in an 802.11 network having a phone conversation and walks across the building, an AP handoff could occur viz. the user's handset is now associated with a different AP than the one it was previously associated with. The AP handoff could occur without IP address change if the handoff is within the same subnet or to another subnet, in which case the IP address of the handset changes. If the IP address changes, then the client needs to register with the server again. The established calls continue to flow in the meantime using the old flow information until the Voice-Engine (VE) is communicated of the new IP address. Voice-engine ensures that the RTP streams going out of the client will have the new IP address when it gets the event.

When a wireless client authenticates using 802.1x, there are a series of messages sent between the wireless client and the wireless access point (AP) to exchange credentials. This message exchange introduces a delay in the connection process. When a wireless client roams from one wireless AP to another, the delay to perform 802.1X authentication can cause noticeable interruptions in network connectivity, especially for time-dependent traffic such as voice or video-based data streams. To minimize the delay associated with roaming to another wireless AP, the wireless equipment can support PMK caching and pre-authentication.

PMK Caching

As a wireless client roams from one wireless AP to another, it must perform a full 802.1X authentication with each wireless AP. WPA allows the wireless client and the wireless AP to cache the results of a full 802.1X authentication so that if a client roams back to a wireless AP with which it has previously authenticated, the wireless client needs to perform only the 4-way handshake and determine new pairwise transient keys. In the Association Request frame, the wireless client includes a PMK identifier that was determined during the initial authentication and stored with both the wireless client and wireless AP's PMK cache entries. PMK cache entries are stored for a finite amount of time, as configured on the wireless client and the wireless AP.

To make the transition faster for wireless networking infrastructures that use a switch that acts as the 802.1X authenticator, the WPA/WPS IE Update calculates the PMK identifier value so that the PMK as determined by the 802.1X authentication with the switch can be reused when roaming between wireless APs that are attached to the same switch. This practice is known as opportunistic PMK caching.

Preauthentication

With preauthentication, a WPA wireless client can optionally perform 802.1X authentications with other wireless APs within its range, while connected to its current wireless AP. The wireless client sends preauthentication traffic to the additional wireless AP over its existing wireless connection. After preauthenticating with a wireless AP and storing the PMK and its associated information in the PMK cache, a wireless client that connects to a wireless AP with which it has preauthenticated needs to perform only the 4-way handshake.

WPA clients that support preauthentication can only preauthenticate with wireless APs that advertise their preauthentication capability in Beacon and Probe Response frames.

Wi-Fi-Cellular Handoff

When the user in an 802.11 network having a phone conversation walks out of the building where there is no or insufficient 802.11 connectivity, the call is handed over to cellular network.

The decision to handoff the call is made by the client. The decision is based on 802.11 signal-strength, channel loading and voice-quality thresholds. Once the decision is made, it is communicated to the server which initiates a call to the client on the cellular network. The client checks the caller-id of the incoming call, compares to the 802.11 caller-id, and if there is a match, accepts the cellular call and drops the 802.11 call leg. On the server side, the server drops the 802.11 call leg to the client, patches the cellular call leg to the other talking party.

Cellular-Wi-Fi Handoff

When the user having a phone conversation on cellular network walks into an 802.11 network, and the handset/user can associate itself with a mobility server, then if the user is talking to another user in the 802.11 network, the call is handed over to the 802.11 network.

The decision to handoff the call is made by the client. The decision is based on availability of sufficient 802.11 signal-strength, channel loading and voice quality. Once the decision is made, it is communicated to the server which initiates a call to the client on the 802.11 network. The client checks the caller-id of the incoming call, compares to the cellular caller-id, and if there is a match, accepts the 802.11 call and drops the cellular call leg. The server drops the cellular call leg to the client, patches the 802.11 call leg to the other talking party.

Power Save

When the handset client is idle on the 802.11 network, the 802.11 miniport goes to sleep. Before going to sleep it tells the AP that it wishes to go to sleep by setting the power save bit in the 802.11 header of every frame. The AP receives the frame, notice the client's wish to enter power save mode. The AP begins buffering the packets for the client while the client's 802.11 miniport is asleep. The miniport consumes very little power while asleep. It wakes up periodically to receive regular beacon transmissions coming from the access point. The power-saving clients need to wake up at the right time when the beacons are transmitted to receive the beacons. TSF (Timing Synchronization Function) assures AP and power-save clients are synchronized. TSF timer keeps running when stations are sleeping. These beacons identify whether sleeping stations have packets buffered at the AP and waiting for delivery to their respective destinations.

When there are no incoming beacons for an extended period of time, the 802.11 miniport is put to sleep. It periodically wakes up, probes the air for APs, if there are none present, it goes back to sleep. In this case, it sleeps for longer duration than previous case.

Features and advantages of the present invention may be better understood with reference to the figures and elaborated discussions that follow.

Communication is an integral part of society that enables people to develop and nurture relationships. The desire to stay connected has led to the proliferation of a variety of telecommunication services (e.g., cellular service, Wi-Fi service, VoIP service, land line service, etc.) and devices (e.g., mobile telephones, multi-mode telephones, desk telephones, IP telephones, etc.). Generally, enterprises have implemented a combination of these telecommunication services and devices in order to provide theirs employees with the flexibility and mobility to promote business and to handle day-to-day activities.

In a typical enterprise, the employees may have desk telephones, which may be associated with extension numbers, connected to a public switched telephone network (PSTN) through a private branch exchange (PBX) of the enterprise. Also, some employees may also have cellular telephones that can perform voice and/or data communication through a cellular network, such as a GSM, CDMA, or UMTS network. Further, some employees may employ IP telephones that are able to connect to the Internet through a wireless local area network (e.g., wireless LAN based on one or more IEEE 802.11 standards) to perform voice and/or data communication. In addition, some employees may also have multi-mode telephones, which are capable of performing voice and/or data communication through two or more communication networks. In an example, multi-mode telephones may have the capability to connect through both a cellular network and the Internet (via a wireless access point).

Enterprises may implement such a multi-network arrangement in an attempt to increase accessibility to theirs employees, thus facilitating communication both internally and with third parties. Unfortunately, the differences and even incompatibilities between different networks and devices have introduced new problems for enterprises.

Consider the situation wherein, for example, an enterprise employee may be away from his desk telephone. Thus, the employee may be unreachable through his desk telephone extension number and incoming calls may be routed to his voicemail. Consequently a caller may have the option of leaving a message on the employee's voicemail, redialing the telephone number at a later time, and/or attempting to reach the employee on an alternative number. The inability to make contact with the employee may cause significant inconvenience to the caller, resulting in an unsatisfactory telephone experience and may even result in loss of businesses to the enterprise.

In an attempt to address the inaccessibility issue, an enterprise may implement a multi-network arrangement. In an implementation of the multi-network arrangement, an employee with a desk telephone extension number may have the option of call forwarding incoming calls to a specific telephone number. Thus, even though the incoming calls may be call forwarded to a multi-mode telephone, which may be associated with multiple network services, the incoming call may only be call forwarded via a specific network as dictated by the specific telephone number provided. Such model does not scale for large deployment. In an example, if the specific telephone number is associated with a cellular telephone number, then the call forwarding will be performed through a cellular network even if a less expensive Wi-Fi network may be available. Similarly, if the specific telephone number is associated with a Wi-Fi telephone number, then the call forwarding will be performed through a Wi-Fi network. However, the employee may still be unreachable if a Wi-Fi network is not available or the employee is not currently connected to the Wi-Fi network. Thus, even though the more expansive cellular network may be available, incoming calls forwarded to a Wi-Fi telephone number are not able to take advantage of the cellular network.

Besides call forwarding, the enterprise may also incorporate next generation mobile communication standards that allow multi-mode telephone users to move between cellular and Wi-Fi networks. The standards include an Unlicensed Mobile Access (UMA) standard that specifies switching control schemes for the carriers of the cellular network to enable multi-mode telephone users to roam between the cellular and Wi-Fi networks.

Generally, the implementation of equipment (e.g., networking equipment and multi-mode telephones) based on the UMA standard may be significantly different by different vendors. Thus, a UMA server that is operated by a carrier may be compatible with a limited set of equipment brands and/or models. As a result, an enterprise that implements a UMA solution provided by a carrier may be faced with limited choices in selecting network equipments and multi-mode telephones. In addition, the flexibility to change carrier may now be dependent upon the enterprise's willingness to expend additional resources to purchase new equipments (e.g., network equipment and multi-mode telephones). The fact that the voice operation control is only within the carrier space it is not desirable for an enterprise.

Since a UMA solution is provided by a carrier, an enterprise may have to rely on the carrier of the cellular network to manage the cellular telephone usage and may have little or no direct control over related policy, service, usage, security, and/or privacy. In an example, the carrier controls the telephone calls and decides if and when switching between networks may occur. Thus, the enterprise may not be able to steer the usage from the more expensive cellular service to the less expensive Wi-Fi service, even if the user has access to the Wi-Fi network.

In accordance with embodiments of the present invention, there is provided a wireless communication system solution that may be implemented by an enterprise. In accordance with one aspect of the present invention, the inventors herein realized that although an enterprise's communication needs may be addressed by different solutions, there is not an integrated approach in which the enterprise retains control of its telecommunication solution. Embodiments of the invention enable the wireless communication system to provide an integrated solution by including a mobility server, which may be internally managed by the enterprise, and a mobility client, which may interact with the mobility server.

In this document, various implementations may be discussed using voice telecommunication requests/sessions as an example. This invention, however, is not limited to voice telecommunication requests/sessions and may be employed for telecommunication requests/sessions that may be related to real time media transfer. Examples, of real-time media may include, but are not limited to, telephone call, instant messaging, email, video transmission, and the like.

As discussed herein, a mobility server refers to a computer system that may manage and/or control both incoming and outgoing media traffic through the enterprise. In an embodiment of the invention, the mobility server may be connected with a plurality of networks. The plurality of networks may be implemented based on different communication standards and may include a wireless local area network (wireless LAN) managed by the enterprise. The plurality of networks may be further expanded to include one or more cellular networks operated by carriers and wireless LANs managed by third parties. In addition, the mobility server may be independent of hardware platforms implemented by the plurality of networks.

In an embodiment of the invention, the mobility server may interact with a mobility client, which may be configured to operate in the plurality of networks. As discussed herein, a mobility client refers to a telecommunication device that includes mobility client software. The telecommunication device (e.g., mobile telephones, multi-mode telephones, desk telephones, IP telephones, etc.) may be of different brand and/or models. In an embodiment, the mobility client may be a multi-mode telecommunication device capable of operating on a plurality of networks.

In an embodiment, the wireless communication system solution may also work with a single mode telecommunication device. For a single mode telecommunication device, the telecommunication device may have mobility client software downloaded onto the telecommunication device making the device a mobile-enabled telecommunication device capable of interacting with the mobility server. In other words, even though the single mode telecommunication device is incapable of roaming between networks, the single mode telecommunication may still benefit from the advantages offered by the wireless communication system solution, such as smoother transition between access points (if an IP telephone), a better voice quality experience, and call forwarding.

In an embodiment, the mobility client may be configured to be associated with a contact number such as, for example, an extension number of an enterprise's main telecommunication line. The mobility client may include client functional modules, which may interact with server functional modules. The client functional modules of the mobility client may be implemented on the application layer of the open systems interconnection (OSI) architecture. Accordingly, the client functional modules may be independent of the operating system of the mobility client. For example, the operating system of the mobility client may be Windows® CE, Windows® Mobile, Linux®, or Symbian®.

In an embodiment of the invention, the mobility server may include mobility server software, which may include a plurality of server functional modules, such as a mobility manager server module, a call control server module, a presence manager server module, a server management module, a database manager module, a policy manager module, a proxy protocol server module, a PBX interface module, a resource manager module, a data protocol/data transaction server module, a SIP stack module, a socket module, and a media manager module and voice quality engine module. In an embodiment of the invention, the mobility client may include mobility client software, which may include a plurality of client functional modules, such as a user interface module, a native application module, a mobility manager client module, a call control client module, a presence manager client module, a proxy protocol server module, a data protocol/data transaction client module, a voice engine module, and a wrapper module. The mobility server application may interact with the mobility client application to handle different telecommunication functions, such as managing telecommunication requests, validating user, performing handoff between the plurality of networks during roaming, modulating real-time media quality (e.g., voice quality, data transfer, etc.), and the like.

In an embodiment of the invention, the mobility server may be configured to store network connectivity information about the mobility client. By using the network connectivity of the mobility client, the mobility server may be configured to route incoming telecommunication requests to the mobility client. The mobility server may also be configured to establish outgoing telecommunication requests from the mobility client using the network connectivity information about the mobility client. The incoming and outgoing telecommunication requests may include voice and/or data requests.

By interacting with the mobility server, a mobility client may now seamlessly roam among the plurality of networks (e.g., cellular network, Wi-Fi networks, PSTN, etc.) with minimal interruptions (e.g., dropped calls, loss of voice quality, background noise, echo, etc.). Therefore, employees of the enterprise may be easily reached through mobility clients. Thus, the enterprise may resolve its accessibility issue without implementing a third party solution, such as a UMA server.

Since all incoming and outgoing telecommunication requests may now be routed through an internal mobility server, the enterprise may now talk control of its telecommunication function. With control, the enterprise may be able to ensure secured and legitimate access to its data. Further, with control, the enterprise may be able to increase a user's experience by routing telecommunication sessions through one or more of the available plurality of networks to prevent a disrupted telecommunication session, to prevent data lost, and/or to minimize degradation of data quality. In addition, with control, the enterprise may manipulate its telecommunication usable cost by routing telecommunication sessions through less expensive available networks. Accordingly, the enterprise now can balance cost, quality, and security while providing a mobile communication system solution.

In an embodiment, a plurality of mobility servers may be deployed at a plurality of sites at the enterprise to reduce tromboning, or routing telecommunication request back and forth. The plurality of mobility servers may be connected through a virtual private network that is managed by the enterprise. The benefit of a plurality of mobility servers may include a reduction in unnecessary telecommunication session delays and inefficient use of network resource.

The features and advantages of the present invention may be better understood with reference to the figures and discussions that follow.

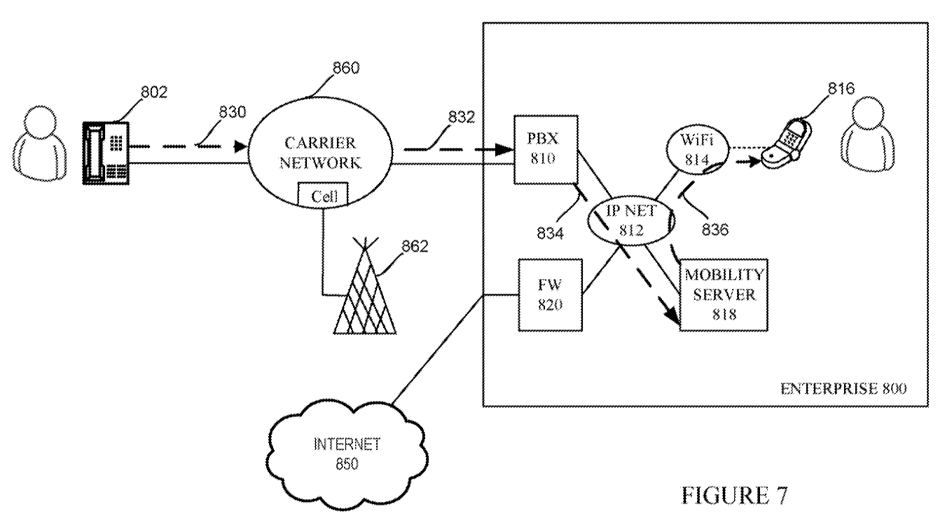

FIG. 7 shows, in an embodiment of the invention, a telecommunication session being established between an external telecommunication device and a mobility client, which is within an enterprise. As discussed herein, a telecommunication device refers to a device that may be employed to send media packets. Examples of telecommunication devices include, but are not limited to, cellular telephones, desk telephones, multi-mode telephones, IP telephones, and the like. As discussed herein, a mobility client refers to a telecommunication device that has installed mobility client application.

Consider the situation wherein, for example, an individual on an external telephone is trying to establish a telecommunication session with an individual on a mobility client. Unlike the prior art, the user of an outside telephone 802 does not have to know multiple telephone numbers in order to make contact with the intended receiving party of the telecommunication request. Instead, the user of outside telephone 802 now only needs access to a single telephone number. In an example, user of outside telephone 802 dials an enterprise 800's main line and an extension number to reach the intended receiving party.

The telecommunication request by the user of outside telephone 802 may traverse through a carrier network 860 (as illustrated by a leg 830) to connect with a user of a mobility client 816 within enterprise 800.

Enterprise 800 may have a wireless communication system, which may include at least a mobility server 818 and mobility client 816. Through an IP network 812, such as an intranet, mobility server 818 may be connected with a wireless local area network represented by Wi-Fi network 814 (or access point 814). Also, through IP network 812 and a private branch exchange 810 (PBX 810), mobility server 818 may be connected with carrier network 860 and/or a cellular network 862, which in turn may be connected with external telecommunication devices, such as outside telephone 802 that is outside a firewall 820 of enterprise 800. Further, through firewall 820, mobility server 818 may be connected with an Internet 850, which may be connected with various other networks. Mobility server 818, IP network 812, firewall 820, PBX 810, and Wi-Fi network 814 are managed by enterprise 800.

As mentioned above, the wireless communication system may further include mobility client 816 that may be utilized by an employee of enterprise 800. Mobility client 816 may be associated with a set of contact numbers (e.g., land line telephone number, IP address, extension number, cellular telephone number, etc.), which include at least one contact number. The method of associating mobility client 816 to a set of contact numbers may be performed by a number of methods, for example, a subscriber identity module (SIM), that is well known in the art.

In an embodiment, the telecommunication request may first be received internally within enterprise 800 by PBX 810 (as shown by a leg 832). PBX 810 may then route the telecommunication request through an internal IP network 812 (e.g., intranet) to mobility server 818 (as shown by a leg 834). In an embodiment, communication between PBX 810 and mobility server 818 may be packet-based communication.

In an embodiment, mobility client 816 may first register with mobility server 818 upon activation. In this scenario, since mobility client 816 is currently located within enterprise 800, mobility client 816 has registered with mobility server via Wi-Fi network 814. Once mobility server 818 has received the registration information from mobility client 816 and has verified that mobility client 816 is a valid and subscribed device, mobility server 816 may accept incoming and outgoing telecommunication request to and from mobility client 816.

Since mobility client 816 has already registered with mobility server 818 via Wi-Fi network 814, mobility server 818 knows to forward the incoming telecommunication request back through IP network 812 to reach mobility client 816 at Wi-Fi access point 814 (as shown by a leg 836).

Since the telecommunication request is routed through mobility server 818, enterprise 800 may be able to manage its telecommunication infrastructure. For example, enterprise 800 may be able to screen incoming telecommunication request, verify and validate user's access, monitor duration of the telecommunication session, and the like.

In an embodiment, mobility server 818 is a server that manages all incoming and outgoing telecommunication sessions. In other words, media traffic (e.g., media packets) may be routed to mobility server 818 before being forwarded to a final destination (e.g., mobility client 816 or outside telephone 802). Mobility server 818 may include mobility server application, which may include a plurality of server functional modules. With mobility server application, mobility server 818 may now manage the enterprise's telecommunication infrastructure.

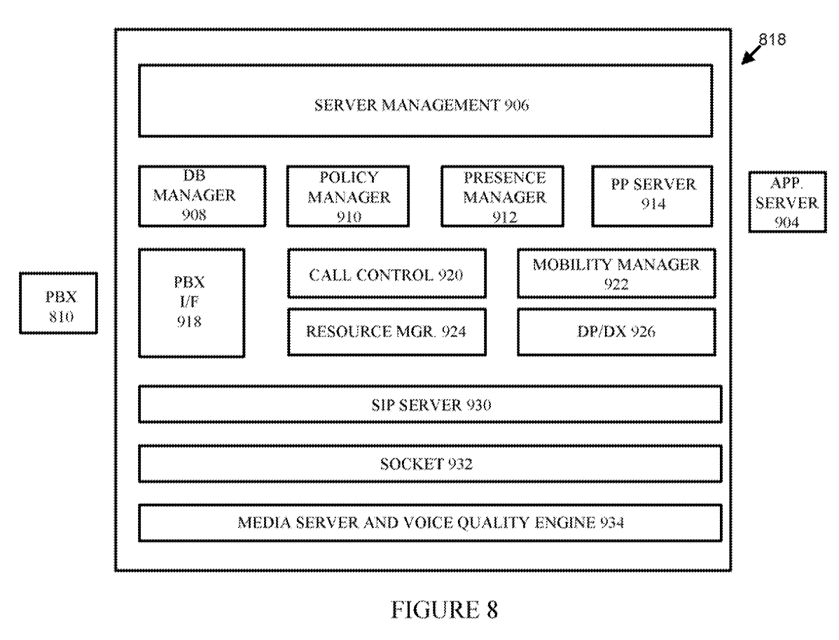

FIG. 8 illustrates, in accordance with one or more embodiments of the present invention, examples of server functional modules that may be implemented in mobility server 818 of FIG. 7. Server functional modules may include, but are not limited to, a server management module 906, a database manager module 908, a policy manager module 910, a presence manager server module 912, a PP server module 914, a PBX I/F module 918, a call control server module 920, a mobility manager server module 922, a resource manager module 924, a DP/DX server module 926, a SIP server module 930, a socket server module 932, and a media server and voice quality engine module 934.

Server management module 906 may be configured to provide a user interface for managing and/or monitoring communication media traffic, users, communication services, and telecommunication devices (such as mobility client 816 of FIG. 7). The user interface may include a web-based interface.

Database (DB) manager module 908 may be configured to manage one or more databases accessed by mobility server 818 while saving data and/or retrieving data. In an example, mobility server 818 may employ database 908 to compare a contact number in a telecommunication request against a list of contact numbers to determine which mobility client may be associated with the incoming contact number. Further, DB manager module 908 may perform other database management tasks such as, for example, data back-up, data recovery, and database update.

Policy manager module 910 may be configured to enforce policy defined by enterprise 800. The policy may include, but are not limited to, telecommunication session privileges, ability to roam, availability of communication service features, and the like.

Presence manager server module 912 may be configured to receive and store a user's presence state from a mobility client such as mobility client 816 of FIG. 7 and/or a mobility manager server module 922. Examples of a user's presence state may include, but are not limited to, online, idle, busy, offline, receiving, text only, voice only, voice message only, and the like. The user's presence state may be viewable by other parties. The user's presence state may be employed to establish willingness to participate in incoming telecommunication request. Thus, the user's presence state may be employed by call control server module 920 to determine whether or not to establish a telecommunication session between mobility client 816 of FIG. 7 and another telecommunication device.

PP server module 914 may represent a proxy protocol software for interacting with an application server 904 (which may be external to mobility server 818) and translating between generic data applications across difference platforms. Example of such generic data applications may include non-voice applications such as email and instant messaging.

PBX I/F module 918, or PBX interface module 918, may be configured to enable mobility server 818 to interface with PBX 810.

Call control server module 920 may be a control plane module responsible for functions pertaining data communication establishment (e.g., voice calls or audio/video/information streaming). The functions may include, but are not limited to, VoIP call processing, SIP (session initiation protocol) proxy server and back-to-back SIP user agent (B2BUA), PSTN call management through PSTN gateways, PBX feature management, and resource and connection management.

Mobility manager server module 922 may be configured to receive and store connectivity information from a mobility client such as mobility client 816 (shown in FIG. 7) when a telecommunication session is established. The connectivity information may include strength of signals received by the mobility client. The connectivity information may be employed to determine when and how to connect the mobility client. Mobility manager server module 922 may also maintain mobility logic for determining whether to let the mobility client perform a handoff.

Resource manager module 924 may be configured to communicate with media server and voice quality engine module 934 to determine if there is sufficient resource for establishing data communication (e.g., voice calls or audio/video/information streaming). Also, resource manager module 924 may forward to mobility manager server module 922 status data about the quality of the telecommunication session received from media server and voice quality engine module 934

DP/DX server module 926 may represent data protocol/data transaction function for secure communication between mobility server 818 and mobility client 816 of FIG. 7. For example, the secure communication may include transmission of the user's presence state and the network connectivity information from mobility client 816 of FIG. 7 to server presence manager server module 912 and mobility manager server module 922, respectively. The secure communication may also include transmission of the mobility client's registration information, communication status, handoff signals, etc.

SIP server module 930 may represent a protocol message decode/encode engine. SIP server module 930 may also performs basic protocol specific tasks such as, for example, standards based message parsing and validation, retransmissions, proprietary message validation, etc.

Socket server module 932 may provide an interface for communicating between various modules and is typically part of the operating systems on which mobility server 818 may run. In FIG. 8, server functional modules shown above socket server module 932 may be configured for signaling; the server functional module shown below server socket server module 932, i.e., media server and voice quality engine module 934 may be configured for managing voice and data traffic.

Media server and voice quality engine module 934 may be configured to monitor and handle IP packets (e.g., voice packets), decode and encode data (e.g., voice), and encryption and decryption of secure transmission of data. In an embodiment, media server and voice quality engine module 934 may be implemented on stand-alone hardware. In an embodiment, media server and voice quality engine module 934 may also be configured to detect imminent handoffs to a cellular network based on lack of arrival of a number of consecutive IP packets.

In an embodiment, media server and voice quality engine module 934 may include a transcoder. As discussed herein a transcoder refers to software that can encode and/or decode data packet into different media data formats (e.g., GSM, G.711, G.729, etc.). In the prior art, transcoding may be performed by either a carrier-managed gateway or a telecommunication device. If the transcoding is performed by the carrier-managed gateway, there may be inefficient use of network resource. In an example, cellular data packet (e.g., GSM) being sent to telecommunication device in an IP network (e.g., Wi-Fi) may first have to be converted into an IP-enabled format (e.g., G.711). Since G.711 format files are of low-compression, the G.711 format files may require a higher bandwidth. If the transcoding is performed by the telecommunication device, which needs to have transcoding capability, the user of the telecommunication device may be burdened with the configuration requirements.

However, by integrating a transcoder into media server and voice quality engine module 934, communication is not limited by media data format. Instead, mobility server may now accept different media data format and convert the data packets into format that may be acceptable by the telecommunication device. As a result, high compression data format may now be more extensively employed to promote efficient utilization of network resource. In addition, the burden of transcoding is no longer the responsibility of the telecommunication device.

Referring back to FIG. 7, mobility client 816 may include mobility client application, which may include a plurality of client functional modules, in an embodiment. Mobility client application may be downloaded onto mobility client 816 to enable mobility client 816 to manage its own telecommunication needs. The mobility client application may be downloaded to mobility client 816 by the user of mobility client 816 through well-known media such as, for example, the Internet or optical storage media. In addition, the mobility client application may enable mobility client 816 to interact with mobility server 818 in order to create an environment that will satisfy the telecommunication needs of user of mobility client 816

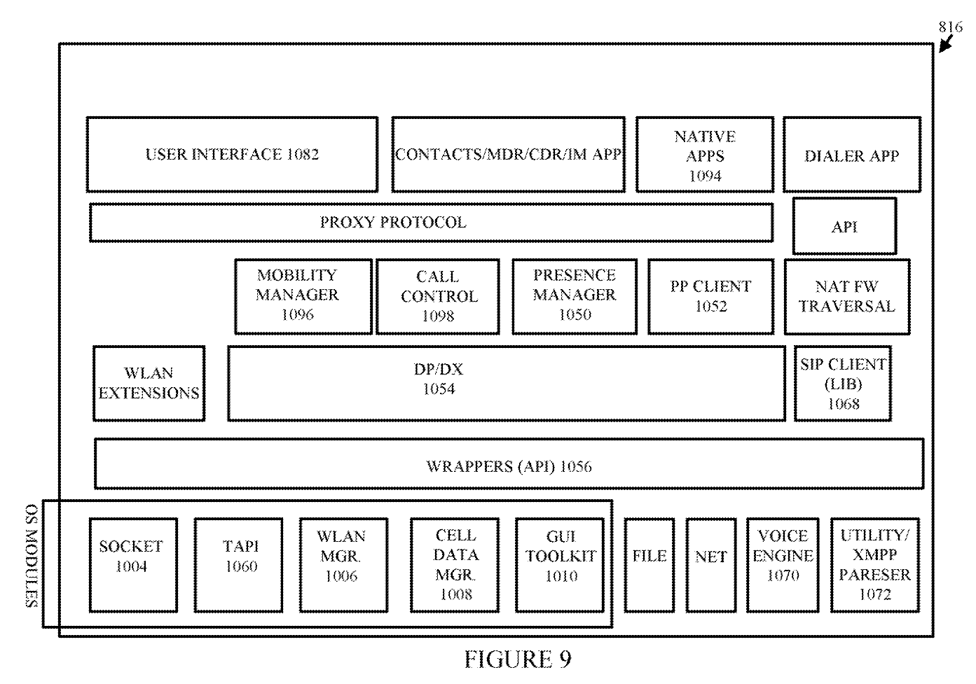

FIG. 9 illustrates, in accordance with one or more embodiments of the present invention, examples of client functional modules that may be part of mobility client application. Mobility client 816 may include both device specific modules and client functional modules. Device specific modules are operating system functional modules that may be provided by the operating system of the mobility client 816. Operating system functional modules may include a socket client module 1004, a TAPI (telephony application programming interface) module 1060, a WLAN (wireless local area network) manager module 1006, a cell data manager module 1008, and a GUI (graphical user interface) toolkit module 1010. Client functional modules may include, but are not limited to, a user interface module 1082, a native applications 1094, a mobility manager client module 1096, a call control client module 1098, a presence manager client module 1050, a PP client module 1052, a DP/DX client module 1054, a wrapper module 1056, a SIP client module 1068, a voice engine module 1070, and a XMPP (extensible messaging and presence protocol) parser module 1072.

User interface module 1082 may be configured to display features and configuration options to the user and to receive user input. User interface module 1082 may also be configured to interact with other client functional modules such as, for example, mobility manager client module 1096 and call control client module 1098.

Native applications module 1094 may include applications that can take advantage of connectivity but will need to be agnostic of the connectivity method used such as, for example, a CRM application or database client.

Mobility manager client module 1096 may be configured to receive and evaluate current state of connectivity with information such as signal strength data and other parameters to make handoff decisions. Criteria for the handoff decisions may be received and stored in mobility manager client module 1096 when mobility client 816 registers with mobility server 818 (shown in FIG. 7). The criteria may relate to signal strength, channel loading, voice quality, and/or data transmission quality.

Call control client module 1098 may be configured to interact with user interface module 1082 and to manage outgoing and incoming data (including outgoing and incoming voice calls) of mobility client 816. For outgoing data, user interface module 1082 may provide instructions to call control client module 1098, and then call control client module 1098 may manage other client functional modules to initiate the outgoing data. For incoming data, call control client module 1098 may instruct user interface module 1082 to inform the user of mobility client 816 of the incoming data. In response, through user interface 1082, the user may provide instructions to call control client module 1098 regarding the incoming data such as picking up or diverting an incoming call.

Presence manager client module 1050 may be configured to indicate the user's presence state, which presence manager server module 912 of mobility server 818 (shown in FIG. 7) may employ to manage incoming call. The user of mobility client 816 may configure the user's presence state using user interface module 1082. Examples of a user's presence state may include, but are not limited to, online, idle, busy, offline, receiving, text only, voice only, voice message only, and the like.

PP client module 1052 may represent proxy protocol for communicating with PP server module 914 of mobility server 818 (shown in FIG. 7).

DP/DX client module 1054 may represent data protocol/data transaction function for secure communication with DP/DX server module 926 of mobility server 818 (shown in FIG. 7).

Wrapper module 1056 may represent application programming interface (API) that may enable the above mentioned client functional modules of mobility client 816 to interact with operation system functional modules such as, for example, telephony application interface protocol 1060 (TAPI 1060) for telephony services. As mentioned above, operating system functional modules are device specific modules that may pre-exist in the operating system of mobility client 816. Wrapper module 1056 may enable the aforementioned client functional modules to be implemented independent of the operating system (e.g., Windows® CE, Windows® Mobile, Linux®, or Symbian®) of mobility client 816. Unlike the prior art, the client functional modules are not dependent upon the operating system since the client functional modules may be implemented on the application layer of the OSI architecture.

In one or more embodiments, the possible client functional modules may further include one or more of SIP client module 1068, voice engine module 1070, and XMPP parser module 1072.

SIP client module 1068 may be configured to interact with SIP server module 930 of mobility server 818 (shown in FIG. 7) for call signaling such as, for example, inviting, OK, and acknowledgement messages between mobility client 816 and mobility server 818 of FIG. 7.

Voice engine module 1070 may be configured to provide one or more of encoding, decoding, echo cancellation, jitter control, and error concealment.

XMPP parser module 1072 may be configured to enable messaging services.

Referring back to FIG. 7, a similar type of connection may be performed by mobility server 818 when the user of mobility client 816 initiates the telecommunication request. The telecommunication request may first be sent to mobility server 818 via Wi-Fi network 814 and IP network 812. Mobility server 818 may first verify the legitimacy of the user who is making the telecommunication request. If the user is not a registered user, mobility server 818 may terminate the request. If the user is a registered user, mobility server 818 may next verify the contact number. Upon identifying the contact number as an external number, mobility server 818 may forward the telecommunication request to PBX 810. Upon receiving the request, PBX 810 may dial the contact number to request carrier network 860 to make contact with the user at outside telephone 802.

### B. AUTOMATICALLY SETUP OF POINT-TO-POINT AND POINT-TO-MULTIPOINT MULTI-MEDIA CONFERENCE CALLS WITH ADMINISTRATOR AND USER CONTROLLED RULES AND PREFERENCES (RENDEZVOUS CALLING)

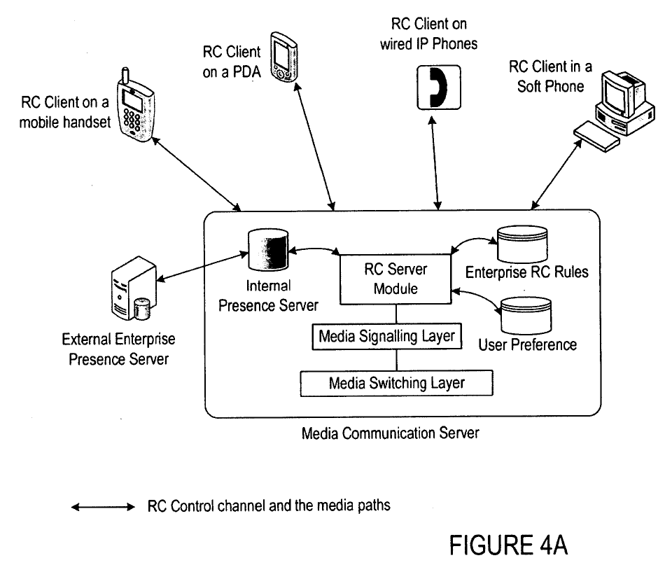

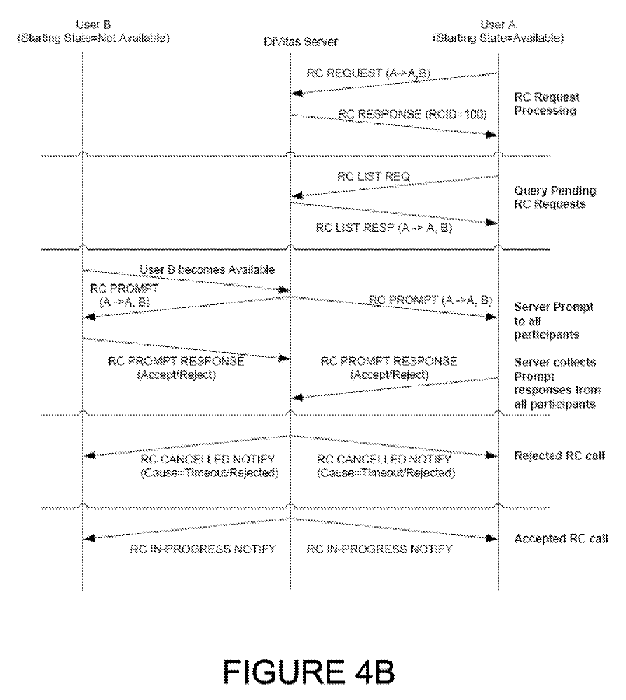

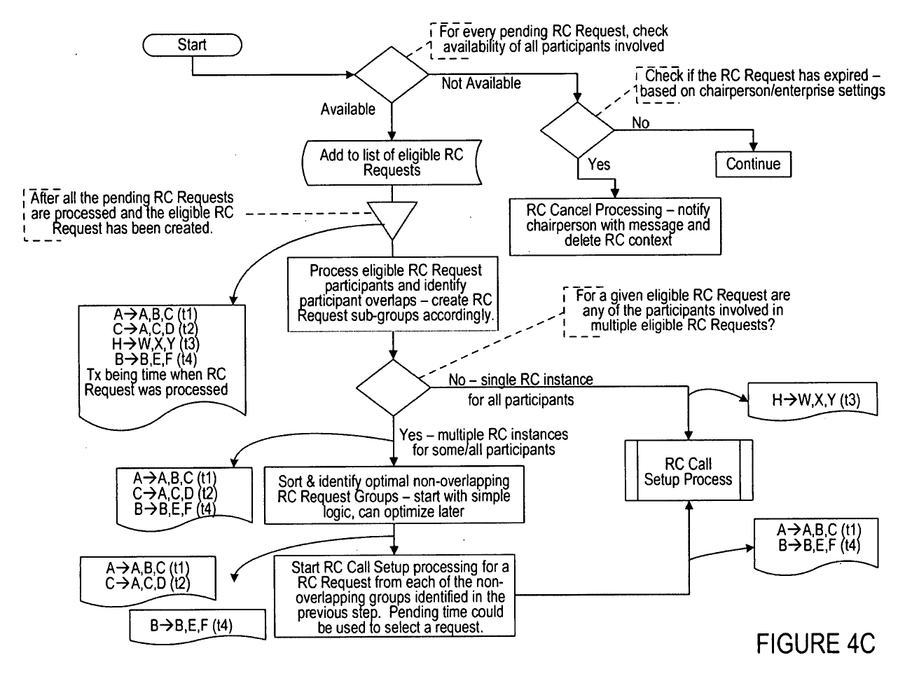

1. This invention is applicable to the field of point-to-point and point-to-multipoint multi-media conferencing using media communication servers. FIGS. 4A-B depict a method in the media communication server to automatically setup point-to-point and point-to-multipoint multi-media conference calls with administrator and user controlled rules and preferences.

2. The current mechanism for setting up PP or PMP media calls is not driven based on any user state or preference. If one or more of the participants is unavailable, the media server will allow the chairperson to leave a voice mail. The only course of action will be for the chairperson to keep trying until all the participants are available or to rely on one or more of the participants to call back and then attempt the conference at later point in time. This process is inefficient and takes up time and resources and is often difficult to manage. The only mechanism is to plan and schedule the conference ahead of time such that all the participants will be available—however there is no guarantee that they will be available at the time of the call. The above issues stem from the lack of coordination and information exchange between the presence servers and the media communication severs in an enterprise.

3. Rendezvous Calling (RC) enables a user to setup a point-to-point (PP) or a point-to-multipoint (PMP) media call (could be voice, video or multimedia) without having to specify the time—the media communications server determines the time of call establishment based on the availability (determined by a variety of factors including presence information, network availability etc.) of all the participants involved and prompts all the participants before setting up the requested call. The notion of availability can be greatly enhanced to take a number of user driven parameters into consideration, thereby enabling the media communications server to take a much more precise decision on when to place the call based on all the participant's preferences. Some of these additional preferences and rules include network administrator controlled rules, user preferences based on time, medium choice, call participants, call priorities etc.

4. Advantages of the Invention Include

Setup and establishment of PP and PMP conference calls that are automatically scheduled taking all the enterprise rules, participant preferences and availability into consideration.

Effective and efficient communication within the enterprise as a result of calls being established at the right moment instead of relying on voice mails for priority-based communications.

6. Overall Architecture

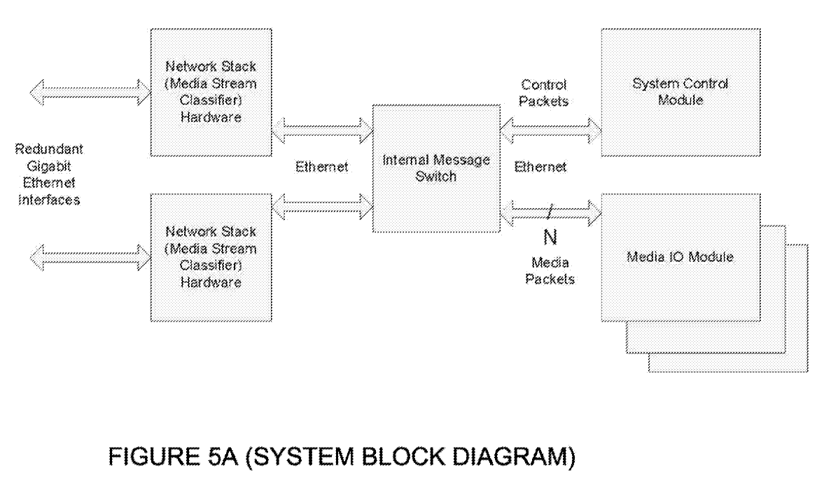

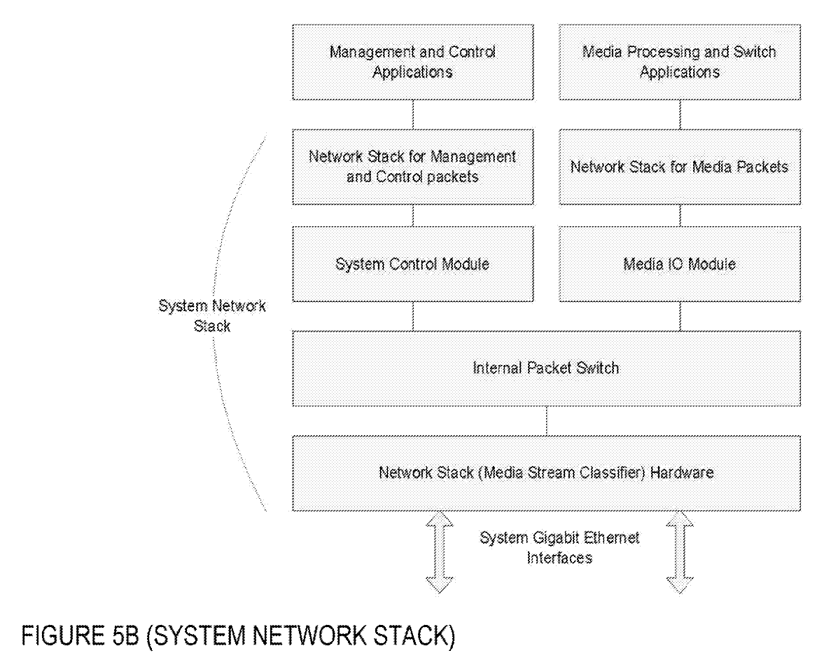

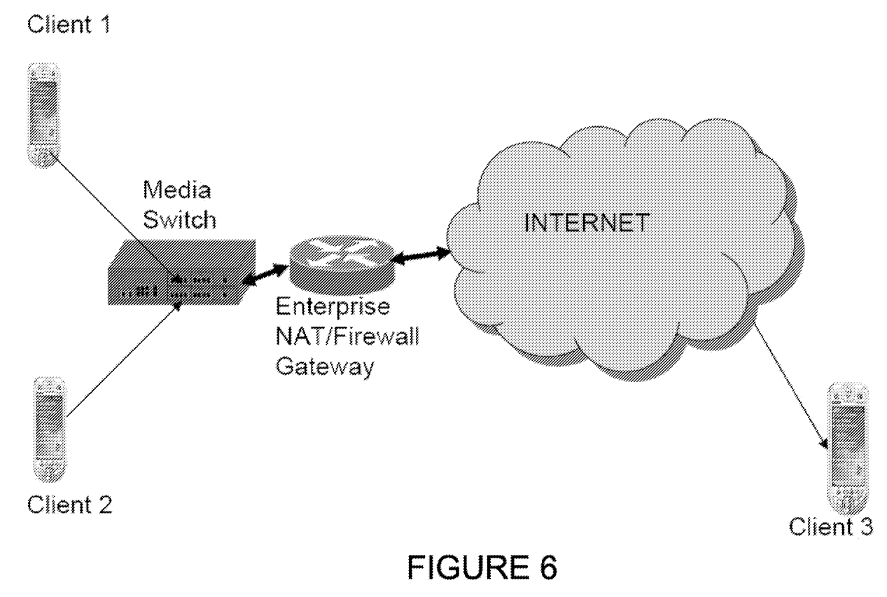

FIG. 5A gives a very high level overview of the RC architecture. The RC architecture has components in the media communication server as well as the RC client. The client in this case could be handsets, soft phones, PDAs etc. The RC client is responsible for managing the user interface to the user and to place a RC Request. It also allows the user to query and track his/her pending RC requests. The RC client will also allow the user to convert a normal PP or PMP call to a RC request if one or more of the participant(s) is deemed “unavailable”. Similarly, when the server does setup a RC call, the client will prompt the user and respond accordingly based on the user feedback. On the server side, the RC logic involves collection and correlation of information from the presence server as well as enterprise applicable rules as configured by the administrator and the user's preferences as configured by the individual users.

When a user places a PP or PMP call from a client, the client software will check the availability of the participants and will prompt the user if one or more of the participants are unavailable as to whether they would like to make it a RC request. The user can also specify for how long he/she would like keep this request pending. The media communications server will track the RC request. When the server concludes that all the participants are available, it will prompt everyone whether they want to go ahead with the call or not. If all the participants acknowledge successfully, the call will be placed. If any of the participants rejects the request, the RC call will be failed and all the participants will be informed of the result. The users can also query the list of pending RC calls (ones they originated as well as the ones on which they are participants) and cancel any requests that they had originated. The server will also employ enterprise as well as user defined rules in determining the best time to go ahead with the call.

7. Administrator and Participant Rules and Preferences for RC

Availability and RC setup decisions are based on a variety of user and administrator controlled rules and preferences.

The following rules and preferences can be used in deciding participant availability before a RC is placed.

Participant opt-out preference for any RC service. The participant can opt out completely or specify time periods when the participant does (or does not) wish to entertain RC calls.
Participant preferences—based on RC priority, RC owner, participant list, time of day, network preference (enterprise Wi-Fi, public Wi-Fi, Cellular etc.), Outlook calendar schedules etc.
Users personal “Allow” and “Block” user lists for limiting the RC calls they would like to participate in.
RC chairperson preference for a time window when the call should be placed.
Administrator controller enterprise rules—cellular privileges for RC, user's RC privileges etc.

8. Logic in the Media Communication Server to Schedule and Place RC Calls.

The logic employed in the media communication server to process and setup is controlled by a variety of factors.
Integration of the presence server in the media communication server with the enterprise and participant driven rules and preferences for determining participant availability and time to place RC.
Support for mandatory and optional participant list for RC.
Ability for participants to early-accept or early-reject a RC. A user can unconditionally accept or reject a RC request even before the RC is setup by the media communication server.
Integration with the Outlook program to use its calendar as an input for the availability decision logic as well as the participant's calendar to reflect the RC call status and any pending RC requests.
Ability to place the RC based on request priority in addition to availability and time of request.
Allow optional RC calls to be placed even when certain participants are busy—using call-waiting to inform and invite them to the RC.

When the server receives a RC Request, a validation check is done to make sure that all the participants involved have signed on for RC services. In addition, the server also checks to make sure no performance impacting thresholds have crossed. If a valid RC request, the server will queue it up and send a RC Response with the status as well as a RC Id associated with that request. If the RC request is found to be invalid or a request that cannot be accepted, the server will send a RC Response with the failure cause back to the originator.

In the event all the participants are available at that instance, the server will process this request like any other PP or PMP call—the media path will be established and a successful RC Response message with the status sent to the originator.

The RC server will periodically go through the list of outstanding RC, requests to determine if any of them are ready for call setup. The flow chart in FIG. 2 captures the logic that is employed by the media communication server to select the RC Requests that are eligible for setup.

Once the list of RC requests that eligible for setup is determined the RC capable media communication server will begin the process of setting up the individual media paths. For all participants involved in the call, send a RC Prompt message. The RC prompt will contain the details about the chairperson, the list of participants, call summary etc. The server will collect the RC Prompt Responses that come back from the clients. It will also keep track of any messages that are sent by the participants. If any of the participants had rejected the RC prompt or there was timeout (lack of response from a client), the server will conclude it is a failed RC call attempt and will send a RC Cancelled Notify to all the participants who responded and the chairperson informing them about the cancelled call as well as the response from the users if any. In the event that all the participants accepted the call, the RC server will put together a PP/PMP request with all the information the media-switching layer requires and will forward this request to the media-switching layer to setup the call. It will also send a RC In-Progress Notification to all the participants about the call being setup

9. Conclusion

The service provided by the RC media communication server will make the task of communicating within the enterprise more effective and will save time for employees who have to depend less on voice mail. This is especially true for employees who are mobile and not tied to a desk phone. The media communication server will take the mobility aspects into consideration while determining the optimum time for placing the conference call.

10. Advantages of the Invention Include
Efficient setup and establishment of PP and PMP conference calls that are automatically scheduled taking all the enterprise rules, participant preferences and availability into consideration.
Effective and efficient communication with in the enterprise because of calls being established at the right moment instead of relying on voice mails to get back and forth and constant calling to check availability. This is all the more true for a work force that is mobile and is not tethered to desk phones.
Capability in the client to provide an option to convert a simple PP or PMP call to a RC request if one or more participants are not available at that time in addition to the standard voice mail service.
Integration of the enterprise presence server in the media communication server with enterprise rules and user preferences.
Integration with Outlook and other calendar programs to let the media communication server manage the conference calls just like meetings.

11. The introduction of logic in the media communication servers to take users availability and preference while pacing a conference all will result in fewer failed call attempts and will also ensure that the calls placed meet their desired objective with all the participants present. This method allows the media communication server to correlate the presence information from the presence server with the administrator controlled enterprise rules and the user controlled user preferences in coming up with the optimum time to place a PP or PMP conference call. This logic in deciding the optimum time results in effective conferencing within the organization and will also save time and money spent in proving this service.

12. RC Client Technical Specifications

The diagram in FIG. 5B gives a very high-level time line for the message exchange between the clients and the media communication server during the course of setting up a RC request and the subsequent establishment of the RC. The following actions will be supported on the RC client for RC capability.

a. RC Request Processing

b. RC Response Processing

c. List and modify/cancel outstanding RC requests

d. Early response (accept/Reject) for outstanding RC requests

e. RC Prompt message processing

f. RC In-Progress and RC-Cancel Notify message processing

13. RC Server Technical Specifications

The diagram in FIG. 5C captures the core logic that is employed by the RC server to support this functionality.
a. RC Request processing
b. Automatic conversion from standard PP and PMP call to RC Request based on participant unavailability and preference.
c. Periodic RC Request processing—timers and selecting RC requests to setup based on all the criteria specified before.
d. Presenting RC Prompt and collecting responses as part of RC call setup.
e. KC media path setup.

To elaborate, embodiments of the invention relate to teleconferencing management. In the prior art, the setting up of a teleconference is a tedious, manual and time-consuming task, requiring the participation of a human being and a lot of patience. For example, if there are five participants, one of the participants or his/her assistant (referred to herein as “the facilitator”) must take the initiative to set up the teleconference ahead via email or IM or another communication means such as telephone or in person with the participants to obtain an agreement pertaining to the teleconference time and method.

For example, the human facilitator may employ an email program to access the calendar of each participant if such a shared calendar is in fact available. Then the facilitator must set up an appointment for each of the participants and obtain their agreement as to the teleconference time and method. Once all parties consent, the facilitator would set up a teleconference facility, typically with the telephone service provider or by designating one of the participants to be the teleconference leader responsible for teleconferencing others in when the designated time to hold the teleconference arrives.

When the time to conduct the teleconference arrives, each participant is then responsible for calling in to the designated telephone number that the facilitator has set up so that he/she can participate in the teleconference. If the participant does not know how to call in and/or unfamiliar with the procedure to enter the requisite user id/password, more time is wasted to assist that participant in making the teleconference call. This is often the case when one of the participants is calling from another country and may require a special dialing sequence, for example. At the designated teleconference time, if one of the participants fails to show up and that participant is needed for the teleconference, it may be necessary to reschedule the teleconference so that all the required participants may be able to participate.

Furthermore, the prior art method of setting up the teleconference call does not take into account the preference of individual participants regarding their preferred communication mode or their time-dependence communication mode (e.g., cell phone from 7 a.m. to 10 a.m., IM from 12 p.m. to 1 p.m., and office phone the rest of the time). This type of accommodation needs to be handled manually and individually with each participant in the prior art when the human facilitator emails or calls around to try to set up the teleconference.

In accordance with embodiments of the present invention, there are provided computer-implemented methods and apparatus for automatically setting up a teleconference among a plurality of teleconferencing participants. Embodiments of the present invention automatically determine the availability and preference of each participant. If, at a given time within the permissible teleconference window, all participants are found to be available, embodiments of the invention employ a rendezvous call (RC) server to automatically confirm the availability of all participants using individual participants' preferred communication mode at the time the inquiry is made. If all required participants consent to conduct the conference, embodiments of the present invention then connect the bearer channels to each participant so that the teleconference may proceed.

As the term is employed herein, a rendezvous call refers to a conference call that is automatically setup and initiated based on parameters that have been entered it) advance by a facilitator. The setup is automatic in part because the RC server monitors for presence status of the participants and employs the participants' preferences and preferred mode of communication for conducting the teleconference. Initiation is automatic in part because each participant is called by the RC server when the RC server determines that it is possible to conduct the teleconference given the parameters that have been furnished regarding the teleconference.

In an embodiment, enterprise-wide RC rules may be applied to modify the preferences settings that have been set by some users. For example, if a high level manager wishes to set up a rendezvous call at a given time, the enterprise RC rules may override a preference setting that has been set by a low-level employee to not hold the teleconference at that time. The enterprise RC rules may also be employed to enforce other RC policies, such as the level of authority given to each participant to invite, whether long distance teleconferencing is permissible, what to do in case of overlapping or conflicting teleconferences or unavailability on the part of certain participants. The enterprise RC rules may be as simple or as complex as required by a given enterprise.

Users can also indicate preferences regarding, for example, their general availability and preferred communication modes. In some cases, users may be able to block or permanently decline certain types of teleconference requests, for example. Users may also specify time-dependent communication preference so that if, for example, a RC were to occur in the morning, the user can be contacted at his desk phone whereby an evening RC should be routed to the user's cellular phone.

A presence server tracks the availability of users to determine whether all required users are available for the purpose of conducting the RC. Using the presence server, embodiments of the invention are able to track whether the participants have logged on and/or the location and/or communication method which a participant has specified. If everyone is available, and their availability coincides with the window that the facilitator has indicated to be a suitable window for conducting the RC, embodiments of the invention automatically inquire the participants and confirm their availability for the rendezvous call. If all parties confirm, embodiments of the invention create the bearer channel to each participant, connect the bearer channel together to create the RC, and the RC can proceed.

The features and advantages of the invention may be better understood with reference to the figures and the discussions that follow.

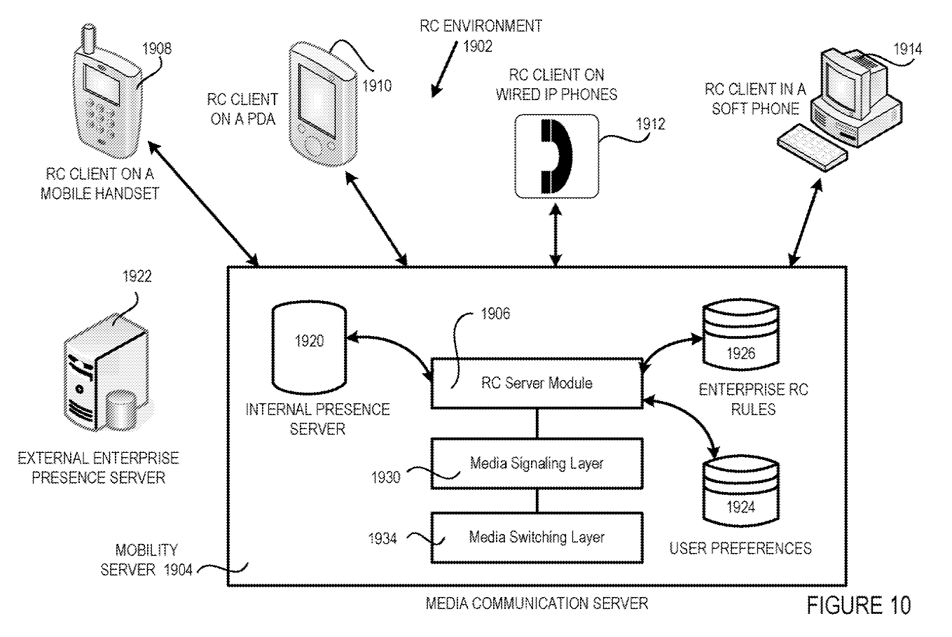

FIG. 10 illustrates, in accordance with an embodiment of the invention, a high level logic block diagram of the automated rendezvous calling environment 1902. In FIG. 10, there is shown a mobility server 1904, representing the physical hardware in which the RC server module 1906 is implemented. One skilled in the art will appreciate that RC server module 1906 may also be implemented on a separate chassis, if desired.

A plurality of RC clients 1908, 1910, 1912, and 1914 are shown. Rendezvous call client 1908 represents a mobile handset; RC client 1910 represents a PDA; RC client 1912 represents a wired IP phone; and RC client 1914 represents a software client executing as a soft phone on a laptop or a desktop computer. Each of RC clients 1908, 1910, 1912, and 1914 executes the RC client software that can be employed to set up rendezvous calls with RC server module 1906, to indicate their preferences. The RC server module will process and/or forward this presence information to one or both of the internal presence server and external presence server as applicable. The preferences of the RC client are also set in the user preference data base 1924, by the RC server module.

A properly authorized user may also employ his RC client to set enterprise RC rules (in enterprise rules database 1926). One skilled in the art will appreciate that any computing device capable of executing the RC client software for interacting with RC server module 1906 can be employed. In addition, an enterprise administrator can also use the management interface provided by the RC server module to set the enterprise RC rules in the enterprise rules database 1926.

When a RC client 1908 wishes to set up a RC, RC client 1908 communicates with RC server module 1906 to indicate the block of time during which the teleconference may take place (e.g., from 8 a.m. to 12 p.m. on Thursday, Dec. 1, 2007), the duration of the teleconference (e.g., 30 minutes), the required participant(s), and optionally the topic of the RC. RC client 1908 may also specify the identity of the required participants and the optional participants, if desired. In an embodiment, the request by a RC client 1908 may be automatically communicated to all required participants so that such required participants may be made aware of the pending request. In another embodiment, the request may be automatically inserted into the electronic calendar (e.g., via an emailed or IM calendar event request) such that the requested RC may be posted to the participants' calendars, and the participants may be made aware of the pending request. If desired, the participants may be asked to comment or accept or reject the proposed RC.

At the start of the specified RC window (e.g., the aforementioned 8 a.m. to 12 p.m. on Dec. 1, 2007), RC server module 1906 inquires via one or both of internal presence server 1920 and external presence server 1922 whether all participants are available. A given participant's availability may be inferred from the participant's calendar and/or log-in activity or by the application of the enterprise conference call rules/user preference. If all participants are not available, RC server nodule 1906 continues to monitor one or both of the presence servers to detect when all participants are available.

When all participants are available, RC server module 1906, employing the rules and preferences set up in enterprise RC rules database 1926 and/or user preference database 1924, sends a notification to each of the participants (e.g., PDA 1910, wired IP phone 1912, and soft phone 1914) to confirm that the RC time has arrived and that the RC is about to begin. If all participants consent, RC server module 1906 then employs media signaling layer 1930 and media switching layer 1934 to accomplish the bearer channel connection among the participants. For example, RC server module 1906 may employ the switching module in mobility server 1904 to establish calls between each participant to the media server 1904 or to the enterprise PBX, wherein the individual bearer channels may be interconnected to create the RC. Thereafter, the RC may begin.

On the other hand, if one or more participants decline, RC server module 1906 may return to the monitoring state to continue to monitor for the next opportunity to set up the RC with the participants when all participants are found to be available. In an embodiment, RC server module 1906 may inquire the declining user as to the time that the declining participant wishes to conduct the RC, and may employ that time to set up the RC again. If a participant continues to decline, the human facilitator may optionally be notified to manually intervene if necessary to facilitate the initiation of the teleconference.

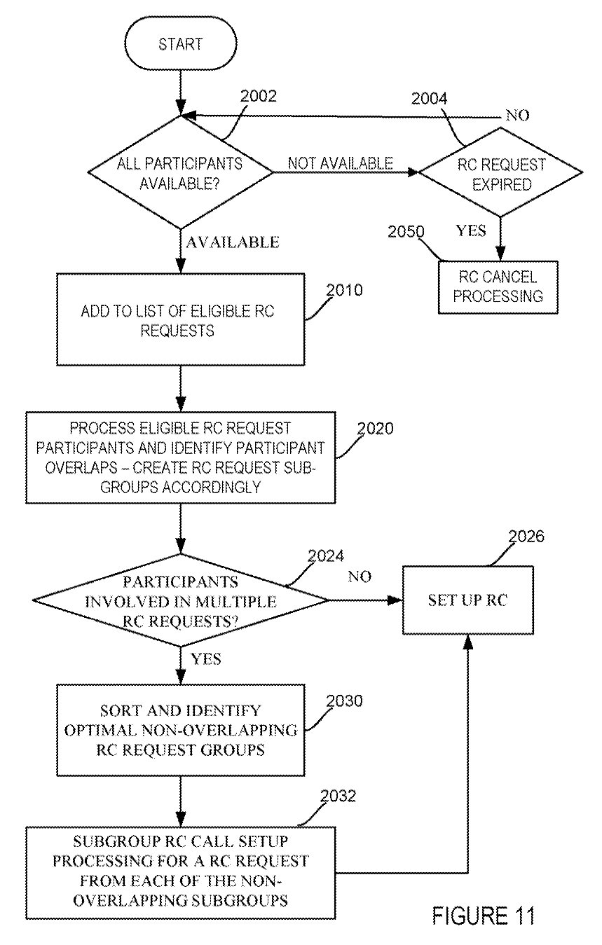

FIG. 11 shows, in accordance with an embodiment, the steps taken by RC server module 1906 in setting up a RC call. In step 2002, RC server module 1906 inquires one or both of internal presence server 1920 and external enterprise presence server 1922 to ascertain whether all participants are available.

If all participants are not available (no branch of 2002), the method proceeds to step 2004 to inquire whether the RC period has expired. If the RC period has not expired, the method returns to step 2002 to continue to monitor whether all participants are available.

On the other hand, if the RC period has expired (the yes branch of 2004), RC cancel processing (2050) is initiated wherein the facilitator is notified that the RC request has expired and it was not possible to set up the RC due to unavailability of participants during the RC request period.

If all participants are available according to the presence server (the yes branch of step 2002, the method proceeds to step 2010 to add the current pending RC request to the list of eligible RC requests).

The difference between a pending RC request aid an eligible RC request relates to the fact that a pending request is a request for which all participants have not been confirmed to be available whereas an eligible RC request is a request for which all participants have been confirmed to be available.

For each eligible RC request, the processing proceeds as follows. In step 2020, the participants associated with an eligible RC request are identified. The same determination is made for all eligible RC requests. Further, overlapped participants are identified. As the term is employed herein, an overlapped participant represents a participant having overlapping eligible RC requests. For example, if a given participant is involved in two different eligible RC requests, both of which have an overlapping RC request period, a potential conflict occurs since a given participant cannot be in two different RCs simultaneously. Thus, the overlapping participants are identified and the RC request sub-groups are created accordingly.

In an embodiment, each participant is assigned only to a single sub-group. That is, no single participant is assigned to two difference sub-groups. Accordingly, the RC associated with each sub-group can proceed independently of the other RCs associated with another sub-group. For example, suppose there are four eligible RC requests that are eligible to be set up as teleconferences (i.e., all participants have confirmed their availability). Suppose for RC 1, the participants are A, B, and C; for RC 2, the participants are A, C, and D; for RC 3, the participants are W, X, and Y; and for RC 4, the participants are D, E, and F.

In this case, two sub-groups can be created, with the first sub-group comprising RC 1, RC 2, and RC 4 (involving participants A, B, C, D, E, and F). The second sub-group comprises the third teleconference RC 3 (involving participants W, X, and Y).

In step 2024, it is ascertained whether, for each eligible RC request, any of the participants are involved in multiple eligible RC requests. If not, the method proceeds to block 2026 wherein the RC for those eligible requests, i.e., those RCs comprising participants that are not involved in any other eligible RC request, is set up. In this example, the third RC involving participants W, X, and Y can be set up in step 2026.

On the other hand, if the participants are involved in multiple RC requests (as in the case of RC 1, RC 2, and RC 4), the method proceeds to step 2030 to sort and identify optimal non-overlapping RC request sub-groups. For example, with reference to the example herein, since RC 1, RC 2, and RC 4 are identified to involve overlapping participants, an algorithm may be created to determine whether some RCs may have a higher priority than others, whether within a sub-group certain RCs do not have overlapping participants, and the like.

In this case, it is ascertained that RC 2 and RC 4 do not have overlapping participants. However, the 1st teleconference RC 1 (involving participants A, B, and C) has a conflicting participant with both the 2nd teleconference RC 2 (involving participants A, C, and D) and the 4th teleconference RC 4 (involving participants D, E, and F). An example algorithm may vote to suggest that, by conducting RC 2 and RC 4, the number of teleconferences that can be conducted simultaneously is maximized.

However, it is possible that another algorithm may determine that RC 1 involves a more pressing topic or a more important participant or group of participants and should take precedence. These different algorithms for resolving conflicts are only examples and may be as simple or as complicated as desired by a given enterprise.

Following the present example, the method proceeds to step 2032 where the RC call setup processing for the RC request from the non-overlapping sub-groups is executed. In this case, the RC call setup processing for RC 2 and RC 4 would be initiated, leading thereafter to the RC call setup process 2026 for these two teleconferences. The RCs that did not get set up may be returned to the list of pending RC requests or may stay as an eligible RC request if desired.

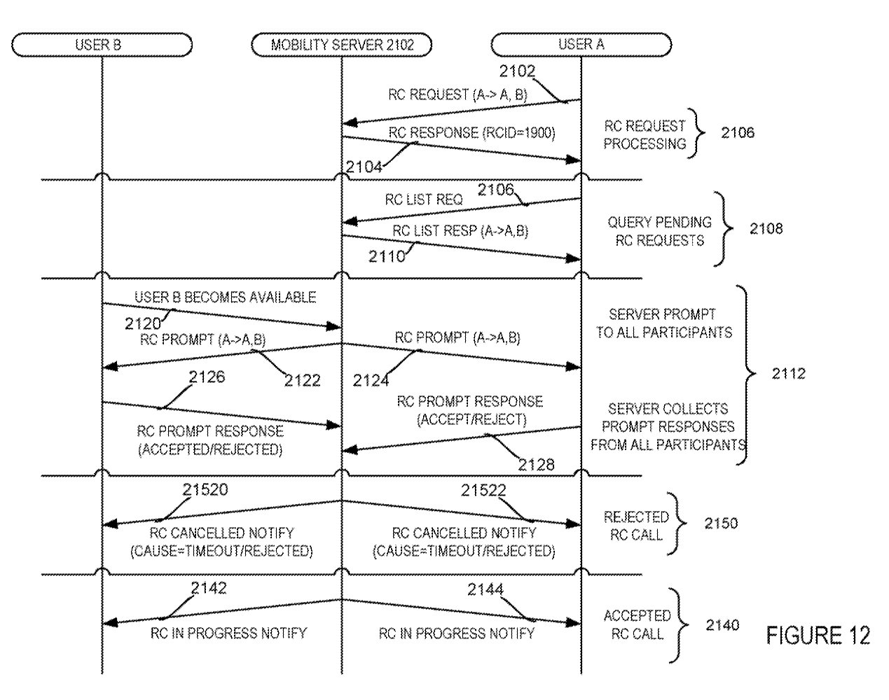

FIG. 12 shows, in accordance with an embodiment, a simple call flow involving two teleconference participants. In this example, user A and user B are requested to participate in an RC via a pending RC request and the RC request period has begun. Furthermore, for the purpose of the present example, user A's starting state is available whereas user B's starting state is not available. As shown in FIG. 12, user A makes an RC request to a mobility server for the RC (2102). Mobility server 2102 responds in 2104 with a rendezvous call ID (RCID) which is, for example, 1900 in this case.

Period 2106 pertains generally to RC request processing. Period 2108 pertains to the processing of pending RC requests. Thus, user A may inquire the list of pending RC requests in which user A has been specified to be a participant. Assuming that no other user has requested that user A participate in another RC, mobility server returns (2110) with the list of teleconferences in which user A is a requested participant. Period 2112 pertains to the confirmation period wherein the presence server has noted that the participants have become available and the RC server module is confirming whether the participants wish to conduct a teleconference. Thus, user B availability is updated with the presence server in mobility server (2120).

Noting the availability of both user A and user B, mobility server 2102 then sends the prompt that confirms whether the user A and user B wish to conduct a teleconference at this time. This is shown by reference numbers 2122 to user B and 2124 to user A, respectively. User B then responds (2126) and user A also responds (2128). If both users accept the teleconference request, processing proceeds according to the steps shown in period 2140. If one or both of the participants decline, processing proceeds according to the steps shown in period 2150. In period 2150, if one or both of user A and user B reject the request by the conference call server module (implemented within the mobility server in this example), mobility server then sends the cancel notify (2152/2154) to one or both of user A and user B indicating that the request is rejected. The notification may also be sent if the pending request has timed out, i.e., the RC request period has expired.

On the other hand, if both participants A and B agree to conduct a teleconference, mobility server 2102 then sends out the notification (2142 and 2144, respectively) to user B and user A to indicate that the teleconference is about to be set up.

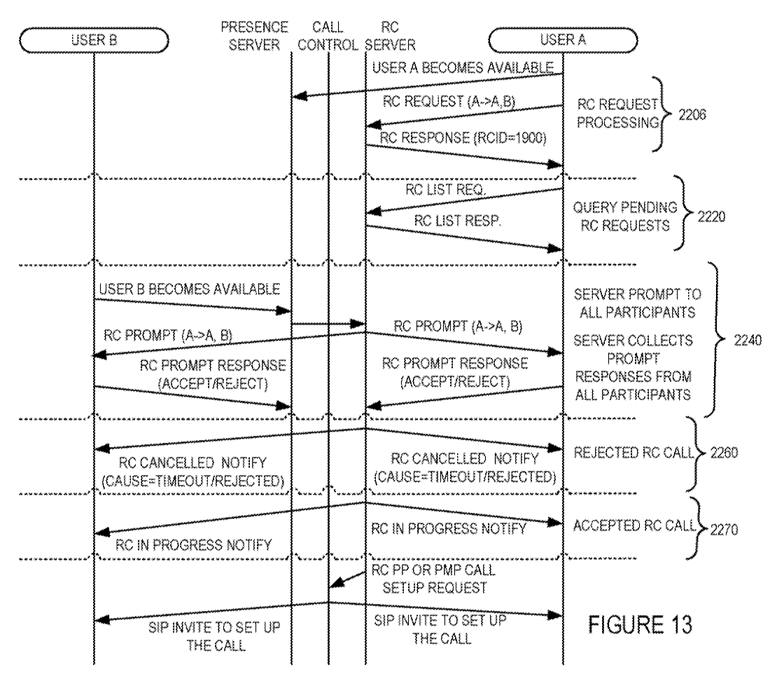

FIG. 13 shows, in accordance with an embodiment of the present invention, the call flow for setting up the teleconference using the parameters specified in the example of FIG. 12, except that the mobility server is now shown to include as constituent components presence server, call control, and RC server. Thus, in the RC request processing period 2206, user A indicates his availability status to the presence server and RC request and RC response are communicated between the RC server and user A. During the query pending RC request period 2220, the request for the pending RC list involving user A and the response with the RC list involving user A are communicated between user A and the RC server as shown. During the prompting period 2240 during which the RC server is attempting to confirm with all participants that the participants are now available and should be conducting the teleconference. Thus, the availability of user B is communicated between user B and the presence server, and the presence server communicates the present status of user B to RC server. The prompt to confirm the teleconference is communicated from the RC server to the users A and B, respectively, and the responses from each user is communicated back to the RC server respectively. In the responses, one or both users may accept or reject the requested teleconference. If one or both users reject the requested teleconference from the RC server, the RC server may send the cancel notification to the users respectively (if rejected).

On the other hand, if both participants accept, the RC server then sends the in progress notification to both participants respectively during accept RC call period 2270. Thereafter, the RC server communicates with call control via a call control message indicating that participants A and B should now be set up in a teleconference. Call control then employs, for example, the SIP invite message to participants to user A and user B rendezvous-enabled communication device to begin setting up the teleconference

As can be appreciated from the foregoing, embodiments of the invention eliminate the manual and time-consuming, steps involved in setting up the teleconference beforehand via one communication mode (e.g., Outlook, IM, in person, email in advance, or telephone in advance) in order to manually confirm with each participant regarding the time and availability for the teleconference. Embodiments of the invention also eliminate the need for a human facilitator to manually connect each participant or for the participant to call in manually, further eliminating the possibility for error or forgetfulness. By using a combination of the presence server, the enterprise RC rules, and the user preferences, the user can be communicated when the user is available within the RC request period using the communication mode preferred by the user and in accordance with the business rules set up by the enterprise. In this manner, teleconferences can be set up in an efficient and automated manner, eliminating reducing wasted time and confusion and/or frustration on the part of the facilitator and/or the participants of the teleconference.

### C. PROVIDING PRESENCE INFORMATION IN COMMUNICATION

In one or more embodiments, the present invention relates to text and voice communication. In particular, the present invention relates to systems and methods for providing user presence information in text and voice communications. For facilitating discussion, text communications may be represented by instant messaging (IM) services, which may be among the most popular text communication services, voice communications may be represented by voice calls, which may be among the most popular voice communication services.

Presently, a typical instant messaging service may enable users to utilize client devices to rapidly exchange text messages. An instant messaging service may also include the feature of displaying user presence state information/messages. In general, instant messaging client applications may allow users to manually select and/or edit the presence message. For example, a user may select and/or edit his/her presence message to be one of “available,” “busy,” “away,” etc. Some instant messaging client applications may automatically provide a presence message such as “idle” when a pointing device associated with the client device is inactive for a predetermined duration and/or a screen saver is triggered on the client device.

The presence message may be displayed on the clients used by the user's contact persons (or contacts, i.e., people included on the user's instant messaging contact list), such that the contacts may determine whether and/or how to communicate with the user based on the presence information. As an example, if a contact sees that the user is “away,” the contact may try to use another communication tool, such as a voice call to the user's mobile phone, for communicating with the user. Typically, the presence information may be limited to only the presence of the user on the instant messaging service, and the contact may not know whether the voice call will reach the user until the voice call is made. Some voice calls that go to voicemail boxes may be unnecessarily made while text messages or email messages are equivalently effective or more effective, waste of time and costs associated with these voice calls may be unnecessarily incurred.

In addition, if the user forgets to correctly set his/her presence information, communication may not be effectively performed. For example, if the user forgets to set the presence message to be “busy” when the user is too busy to respond to text messages, the user's contacts may still send messages to the user and expect instant responses. As a result, the user may be unnecessarily disturbed, the user's contacts may be frustrated given no timely responses, time may be wasted, and/or misunderstanding may be incurred.

A typical voice communication service generally does not enable users to configure and provide presence information. A caller of a voice call typically may not know whether the call will reach the called party, go unanswered, or be routed to the called party's voicemail box until the call is made. As a result, a substantial amount of less effective voice calls may be made, with time and costs wasted, when instant text messages are more effective and desirable, such as when the called parties are attending meetings, watching movies, etc.

One or more embodiments of the present invention relate to a method for facilitating communication among multiple users with one or more of the above-identified inefficiency and ineffectiveness problems avoided or reduced. For facilitating discussion, the users may include at least a first user and a second user, wherein the first user may utilize a first device (or first client device), and the second user may utilize a second device (or second client device). The method may reduce the users' burden in performing communication and may improve the effectiveness of communication among the users.

The method may include associating a plurality of possible device states with a plurality of possible presence states. The possible device states may pertain to the first device. For example, the possible device states may relate to one or more of network utilization, locations, the movement speed, the orientation, calendar events, operation modes, etc., concerning the first device. The possible presence states may pertain to communication modes of the first user. For example, the possible presence states may include one or more of a text-communication-only state, a voice-communication-only state, an on-a-call state, an unavailable-for-text-and-voice-communications state, an available-for-text-and-voice-communications state, etc.

The method may also include determining the current device state of the first device and then setting the communication presence state of the first user according to the current device state. For example, the communication presence state of the first user may be set as a first presence state if the device state is a first device state; the communication presence state of the first user may be set as a second presence state if the device state is a second device state; and so on. The first presence state and the second presence state may be among the possible presence states. The first device state and the second device state may be among the possible device states.

The method may also include providing information (such as a default message or a customized message) concerning the communication presence state of the first user to other users through other devices, such as providing a presence message to the second user through the second device.

As an example, if the first user goes from his/her office to a meeting room, since text communication may be the most effective for communicating with the first user when the first user is in a meeting, the presence state of the first user may be automatically changed from the available-for-text-and-voice-communications state to the text-communication-only state without requiring the first user to manually change his/her presence state on the first device. Accordingly, a message concerning the first user's presence state that is displayed on the second device may be automatically changed from “IM me or call me” to “Cannot answer calls; IM ok,” as previously customized by the first user.

Advantageously, the method may optimize the effectiveness for communication among the users without requiring the users to manually change presence states. The method may also provide presence state information concerning voice communication. As a result, the waste of time and costs associated with potential ineffective voice calls may be avoided.

One or more embodiments of the invention may relate to one or more devices for performing one or more steps in the method.

The features and advantages of the present invention may be better understood with reference to the figures and discussions that follow.

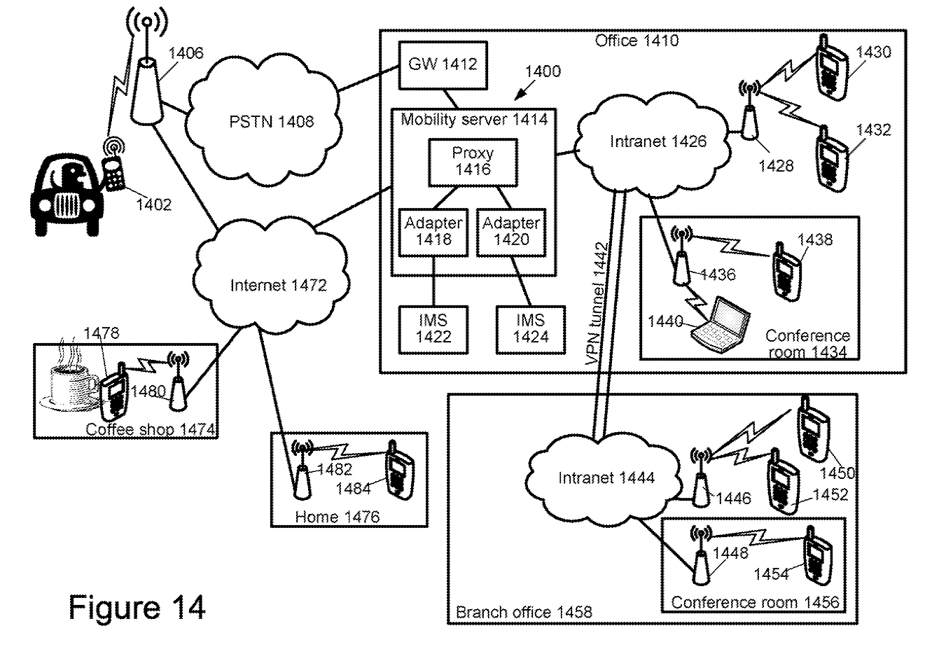

FIG. 14 shows a schematic diagram illustrating a communication system 1400 including a mobility server 1414 and client devices (such as one or more of clients 1402, 1430, 1432, 1438, 1440, 1415, 1417, 1454, 1484, and 1478) for providing communication services including user presence information features in accordance with one or more embodiments of the present invention.

Mobility server 1414 may include one or more server functional modules similar to one or more server functional modules of mobility server 818 discussed with reference to the examples of FIGS. 8-9. For example, mobility server 1414 may include a presence manager server module similar to presence manager server module 912 discussed with reference to the example of FIG. 8 for receiving and storing users' presence state information from clients and/or a mobility manager server module in mobility server 1414. Examples of a user's presence state may include one or more of online, idle, busy, on a call, offline, receiving, text only, voice only, voice message only, available on both text and voice, unavailable on both text and voice, etc. The user's presence state may be viewable by other parties using other client devices. The user's presence state may be employed to establish willingness to participate in incoming telecommunication request. The user's presence state may also be employed by a call control server module in mobility server 1414 to determine how to route communication traffic.

Mobility server 1414 may also include a proxy 1416 and one or more adapters, such as adapters 1418 and 1420. Proxy 1416 may serve as an interface between the clients and the presence manager server module. Additionally or alternatively, proxy 1416 may serve as an interface between the clients and one or more text messaging servers, such as instant messaging servers 1422 and 1424, which may enable instant messaging service features, monitor user presence states, and/or broadcast user presence state information through proxy 1416. The adapters may translate messages between the text messaging servers and proxy 1416. For example, adapter 1418 may perform translation between instant messaging server 1422 and proxy 1416, and adapter 1420 may perform translation between instant messaging server 1424 and proxy 1416. With the translation performed by the adapters and the interface provided by proxy 1416, the users of the clients may be agnostic with respect to the different text messaging servers. Different text messaging services provided by different text messaging servers may be provided to a user utilizing a single user interface on the client device. The user may not need to utilize multiple user interfaces for text messaging services provided by different text messaging servers. Advantageously, user experience and productivity may be improved.

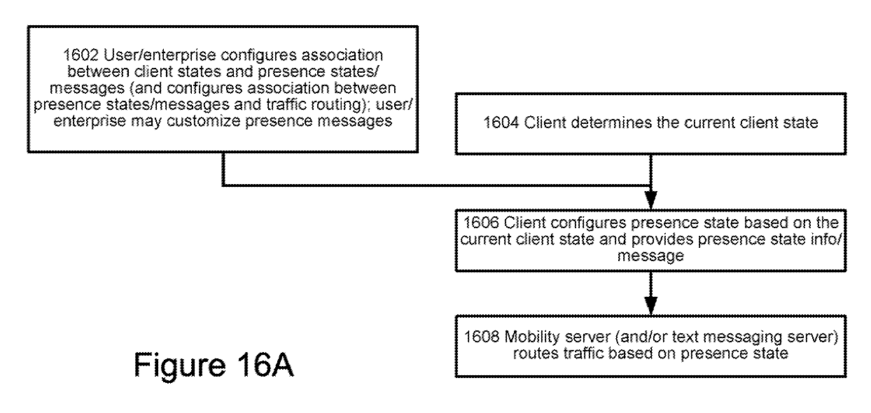

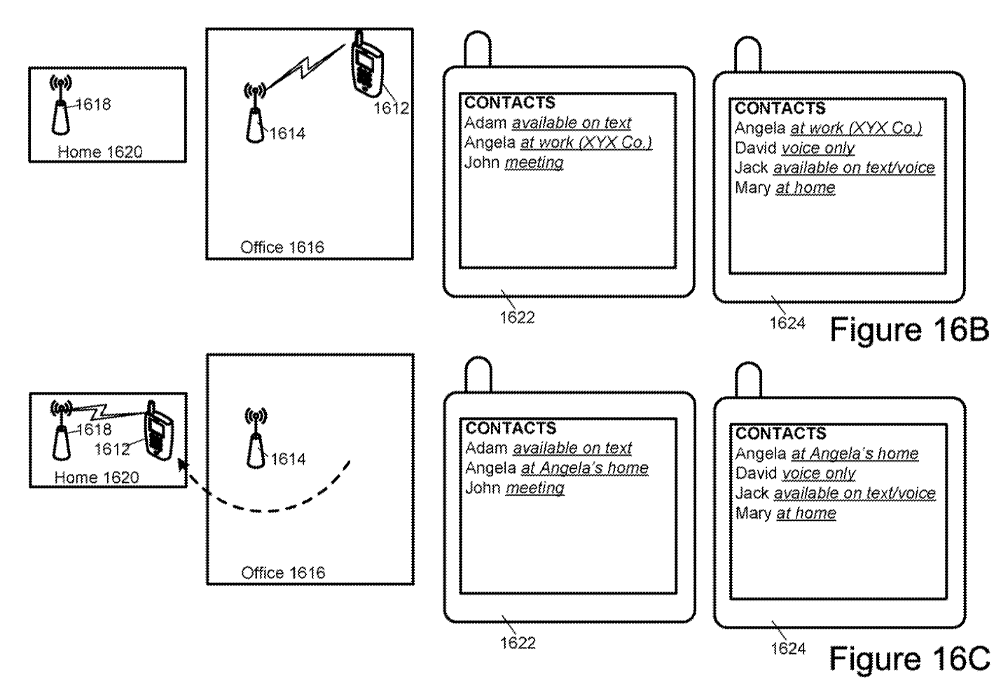

Each of the clients may include one or more client functional modules similar to one or more client functional modules of mobility client 816 discussed with reference to the examples of FIGS. 8 and 10. As an example, client 1402 may include a presence manager client module similar to presence manager client module 1015 discussed with reference to the example of FIG. 9 for providing the client 1402 user's presence state to the presence manager server module of mobility server 1414 and/or to the text messaging servers through proxy 1416. The client 1402 user may configure the user's presence state utilizing a unified user interface on client 1402, for example, similar to user interface module 1082 discussed with reference to FIG. 9. In one or more embodiments, the user's presence state may be automatically configured and/or changed by client 1402 based on one or more device states of client 1402, as further discussed with reference to the example of FIG. 16A. The presence manager client module may also receive presence information concerning other users from the presence manager server module and/or the text messaging servers. Accordingly, the presence manager client module may provide the presence information concerning other users through the unified user interface to the client 1402 user.

In the example of FIG. 14, the clients may be in various device states (e.g. various locations) and may be coupled with mobility server 1414 through various connections. Mobility server 1414 may be implemented at a premise of the enterprise, such as an office 110. The users of the clients may represent members of an enterprise and may have various presence states for voice and text communication. The presence states may be configured/changed by the users, the clients, and/or

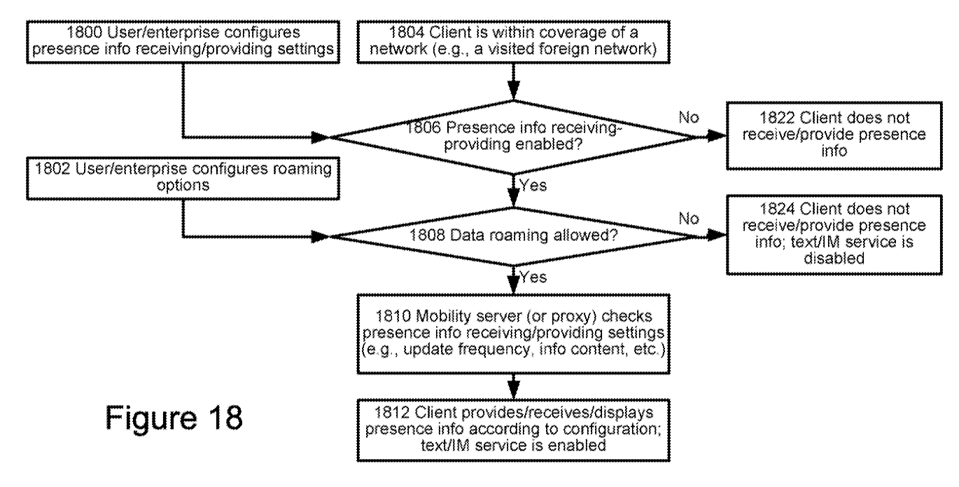

The client 1402 user may be driving a car on the road. Client 1402 may be coupled with mobility server 1414 through a radio base station 1408 (an example of a communication network element), a public switched telephone network 1408 (PSTN 1408), a gateway 1412, and/or the Internet 1472. Since voice communication is most effective for the client 1402 user, the presence state of the client 1402 user may be configured/changed to be “voice only” by the client 1402 user, client 1402 (e.g., the presence manager client module therein), and/or mobility server 1414. In turn, instant messaging server 1422, instant messaging server 1424, and/or mobility server 1414 (e.g., presence manager client module) may broadcast the client 1402 user's presence state information/message to other clients that are coupled with mobility server 1414. If client 1402 is out of the coverage of the home network and is within the coverage of a visited network, the client 1402 user, client 1402, and/or mobility server 114 may also configure and/or determine the client 1402 user's presence state and associated information delivery (e.g., frequency, content, data amount, etc.) based on roaming-related criteria for optimizing cost-effectiveness in communication, as further discussed in the example of FIG. 18.

The client 1478 user may be in a coffee shop 1474 outside of the premises of the enterprise. Client 1478 may be coupled with mobility server 1414 through a public access point 1480 (another example of a communication network element) and Internet 1472. The presence state/message of the client 1478 user may be configured/changed to be “available on both voice and text” by the client 1478 user, client 1478 (e.g., the presence manager client module therein), and/or mobility server 1414. Instant messaging server 1422, instant messaging server 1424, and/or mobility server 1414 (e.g., presence manager client module) may broadcast the client 1478 user's presence state information/message to other clients. Since client 1478 is connected to public access point 1480 (e.g., operated by coffee shop 1474 and/or a Wi-Fi service provider), but not an access point owned by the enterprise, the client 1478 user, client 1478, and/or mobility server 114 may also configure and/or determine the client 1478 user's presence state/message based on roaming-related criteria, as further discussed in the example or FIG. 18.

The client 1484 user may be at the user's home 1476. Client 1484 may be coupled with mobility server 1414 through the user's home access point 1482 and Internet 1472. The presence state/message of the client 1484 user may be configured/changed to be “unavailable on both voice and text” by the client 1484 user, client 1484 (e.g., the presence manager client module therein), and/or mobility server 1414, such that the client 1484 user may not be disturbed by business communications during the user's private time. Accordingly, instant messaging server 1422/1424 and/or mobility server 1414 may broadcast the client 1484 user's presence state information/message to other clients.

The users of clients 1430, 1432, 1438, and 1440 may be in office 1410 of the enterprise. Clients 1430 and 1432 may be coupled with mobility server 1414 through an enterprise access point 1428 and an intranet 1426. The presence state/message of each of the client 1430 user and the client 1432 user may be configured to be “available on both voice and text” by the respective user, the respective client, and/or mobility server 1414. As another example, the presence state/message of the client 1430 user may be configured to be “on a call” by the respective user, the respective client, and/or mobility server 1414 if the client 1430 user is engaged in a phone call. The client 1438 user and the client 1440 user may be in a conference room 1434 in office 1410, and clients 1438 and 1440 may be coupled with mobility server 1414 through a conference room access point 1436 and intranet 1426. Since text communication may be the most effective when the recipient is in a meeting, the presence state/message of each of the client 1438 user and the client 1440 user may be configured to be “text only” by the respective user, the respective client, and/or mobility server 1414. In one or more embodiments, the client and/or mobility server 1414 may automatically configure the presence state based on at least an identifier of access point 1436. The present state information/message may be accordingly broadcasted to other users by instant messaging server 1422/1424 and/or mobility server 1414.

The users of clients 1415, 1417, and 1454 may be in a branch office 1458 of the enterprise. Clients 1415, 1417, and 1454 may be coupled to mobility server 1414 through an enterprise access point 1446 or a conference room access point 1448, an intranet 144, a virtual private network tunnel 1442 (VPN tunnel 1442), and intranet 1426. Other than the involvement of VPN tunnel 1442, the presence states/messages of client 1415 and 1417 users may be configured as “available on both voice and text” and broadcasted in a way similar to the way in which the presence state/message of the client 1430 user is configured and broadcasted; the presence state/message of the client 1454 user, who is attending a meeting in a conference room 1456, may be configured as “text only” and broadcasted in a way similar to the way in which the presence state/message of the client 1438 user is configured and broadcasted.

As can be appreciated from the example of FIG. 14, embodiments of the invention may improve user experience and productivity by providing a unified user interface for various voice and text communication services. Embodiments of the invention may also provide comprehensive presence information for voice and text communications. Accordingly, ineffective voice calls and text messages may be avoided or reduced. Advantageously, communication effectiveness and efficiency may be improved for the users; communication costs may be reduced and productivity may be improved for the enterprise.

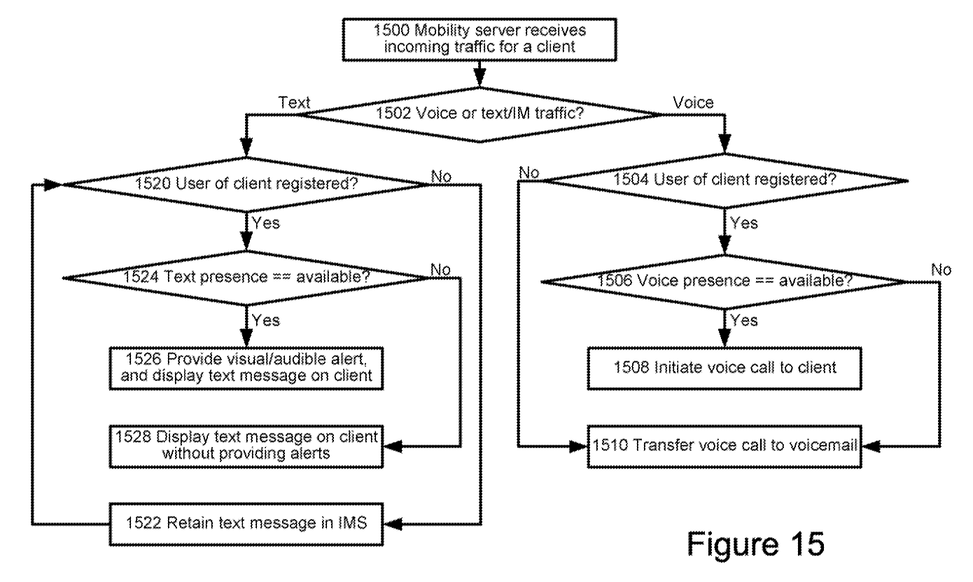

FIG. 15 shows a flowchart illustrating a method for routing communication traffic based on presence state settings in accordance with one or more embodiments of the present invention. The method may enable effective communication traffic routing according to comprehensive possible presence states.

In step 1500, a mobility server (such as mobility server 1414 discussed with reference to the example of FIG. 14) may receive incoming communication traffic for a client (such as one of the clients discussed with reference to the example of FIG. 14).

In step 1502, the mobility server may determine whether the incoming communication traffic is voice traffic or text traffic (e.g., instant messaging traffic). If the incoming communication traffic is voice traffic, control may be transferred to step 1504; if the incoming communication traffic is text traffic, control may be transferred to step 1520.

In step 1504, the mobility server may determine whether the user of the client has been registered, e.g., whether the user has logged in and has been authenticated. If the user of the client has been registered, one or more keep-alive messages will be exchanged between the mobility server and the client, and control may be transferred to step 1506. If the user has not been registered, control may be transferred to step 1510, in which the mobility server may transfer the incoming voice traffic to the user's voicemail box.

In step 1506, the mobility server (or the proxy therein, e.g., proxy 1416 discussed in the example of FIG. 14) may check the user's presence state to determine whether the user is available for voice communication. If the user's presence state indicates that the user is available for voice communication, control may be transferred to step 1508, in which the mobility server may initiate a voice call to the client. If the user's presence state indicates that the user is unavailable, e.g., the user's present state is “on a call”, “text only”, or “unavailable,” control may be transferred to step 1510, in which the mobility server may transfer the incoming voice traffic to the user's voicemail box.

In step 1520, the text messaging server or servers (such as instant messaging servers 1422 and 1424 discussed in the example of FIG. 14) coupled with the mobility server may determine whether the user of the client has been registered, e.g., whether the user has logged in and has been authenticated. If the user of the client has been registered, control may be transferred to step 1524. If the user has not been registered, control may be transferred to step 1522, in which the text messaging server or servers may retain the text traffic (i.e., the text message) until the user has been registered.

In step 1524, the client may check the user's presence state to determine whether the user is available for text communication. If the user's presence state indicates that the user is available for text communication, control may be transferred to step 1526, in which the client may provide one or more visual and/or audible alerts and may display the text message. If the user's presence state indicates that the user is unavailable, control may be transferred to step 1528, in which the client may display the text message (e.g., in a chat window) without providing any alerts.

As can be appreciated from the example of FIG. 15, embodiments of the invention may effectively route communication traffic according to integrated, comprehensive presence state options that include both text-communication states and voice-communication states.

FIG. 16A shows a flowchart illustrating a method for setting and providing user presence state information and/or presence messages based on client device state information in accordance with one or more embodiments of the present invention. The method may reduce user operation, thereby reducing burden on users and improving user experience. The method may also optimize communication mode selection and communication traffic routing, thereby improving communication effectiveness.

In step 1602, the user interface module and the presence manager client module of a client device (such as client 130 discussed in the example of FIG. 14) may enable the user of the client or an operator of the enterprise to configure the association between client device states (hereinafter interchangeably “client state” or “device state”) and presence states/messages for the client/device. For example, the client states may relate to one or more of the network utilization of the client, the location of the client, the movement speed of the client, the orientation of the client, the profile/mode setting of the client, and one or more calendar events recorded on or retrieved by the client, etc. The presence states may include one or more of online, idle, busy, on a call, offline, receiving, text only, voice only, voice message only, available on both text and voice, unavailable on text and voice, etc. The presence messages, which are to be displayed on other clients listed on the user's contact list, may include one or more default messages that reflect one or more of the presence states and/or preferred communication modes.

Additionally or alternatively, the presence messages may include one or more customized messages selected or entered by the user or the operator, such as “out for lunch,” “away from office,” “at work (XYZ Company),” “at Angela's home,” etc. For example, one or more embodiments may enable a user to look up a list of WiFi access points, select the user's home WiFi access point, and configure the presence message associated with the user's home WiFi access point to be “Angela's home”. One or more embodiments may enable an enterprise system administrator to associate various presence messages with various WiFi access points.

FIG. 16B shows a schematic diagram illustrating the presence message of a user, Angela, seen by the user's contacts when the user is at work in accordance with one or more embodiments of the present invention. When the user is at work and the user's device 1612 utilizes an enterprise WiFi access point 1614 at the office 1616, the presence message of the user shown on the user's contacts' devices, such as device 1622 and device 1624, may be, for example, “at Work (XYZ Co.)”, “in conference room A”, or “meeting”.

FIG. 16C shows a schematic diagram illustrating the presence message of the user seen by the user's contacts when the user is at home in accordance with one or more embodiments of the present invention. When the user returns home 1620 and the user's device 1612 utilizes the user's home WiFi access point 1618, the user's presence message seen by the user's contacts (as shown on devices 1622, 1624, etc.) may automatically change to “at Angela's home”.

Optionally, the user or the operator may also customize the association between presence states and communication traffic routing modes, instead of utilizing the default routing, for which an example is discussed in the example of FIG. 15.

Referring back to FIG. 16A, in step 1604, the client may determine the current client state. For example, the client may determine the location based one or more of the identifier of the Wi-Fi access point or the radio base station (or sector) that the client currently communicates with, the domain name associated with the access point, information provided by a global positioning system (GPS) module in the client, etc. The client may determine the movement speed based on information provided by a global positioning system (GPS) module in the client. The client may determine the orientation of the client utilizing one or more sensors and/or gyroscopes in the client. The client may determine the current client device operation profile/mode set by the user and/or one or more mechanisms in the client, such as one of “airplane”, “meeting,” “silence,” “outdoors,” etc. The client may determine the current event(s) by checking the user's calendar stored on the client or a remote server against the current date and time.

In step 1606, the client may set the presence state and/or presence message based on the current client state. The client may also provide the present state information and/or the presence message to the mobility server and/or one or more text messaging server (such as mobility server 1414 and instant messaging server 1422/1424).

For example, client 1438 shown in the example of FIG. 14 may represent a mobile phone with the operation mode currently set as “meeting” by the user. Alternatively or additionally, client 1438 may determine, e.g., based on the information provided by one or more sensors of client 1438, that client 1438 is disposed face-up. According to the “meeting” operation mode and/or the face-up orientation, client 138 may configure/change the user presence state as “text only” and may provide a customized or default presence message such as “text only, cannot take voice calls” to mobility server 1414 and/or instant messaging server 1422 such that the presence message may be broadcasted to other clients.

As another example, client 1430 shown in the example of FIG. 14 may determine that client 1430 is engaged in a voice call. Accordingly, client 1430 may configure the user presence state as, for example, “on a voice call” and may provide a customized or default presence message such as “on a call” to mobility server 1414 and/or instant messaging server 1422 such that the presence message may be broadcasted to other clients.

As another example, client 1484 shown in the example of FIG. 14 may determine, based on the identification information provided by access point 1482, that client 1484 is utilizing the user's home network for communication. Alternatively or additionally, client 1484 may determine, utilizing a calendar, that it is time for a private event, e.g., the user's mother's birthday party. Accordingly, client 1484 may configure/change the user presence state as, for example, “unavailable on text and voice” and may provide a customized or default presence message such as “private time—please do not disturb” to mobility server 1414 and/or instant messaging server 1422 such that the presence message may be broadcasted to other clients.

As another example, client 1402 shown in the example of FIG. 14 may determine, based on the speed information provided by a GPS module in client 1402, that the movement speed of client 1402 has reached (or has been greater than) a predetermined threshold, e.g., 5 miles per hour. Accordingly, client 1402 may configure/change the user presence state as, for example, “voice only” and may provide the customized or default presence message “driving—no text message, please” to mobility server 1414 and/or instant messaging serve 1422 such that the presence message may be broadcasted to other clients.

In step 1608, the mobility server (and/or the text messaging server) may route the incoming communication traffic based on presence state, for example, in a process similar to the process discuss with reference to the example of FIG. 15.

As can be appreciated from the example of FIG. 16A, the configuration of user present states may be automatically performed by the client to optimize incoming traffic routing. Advantageously, the burden on the user may be reduced, and the effectiveness of communication may be improved.

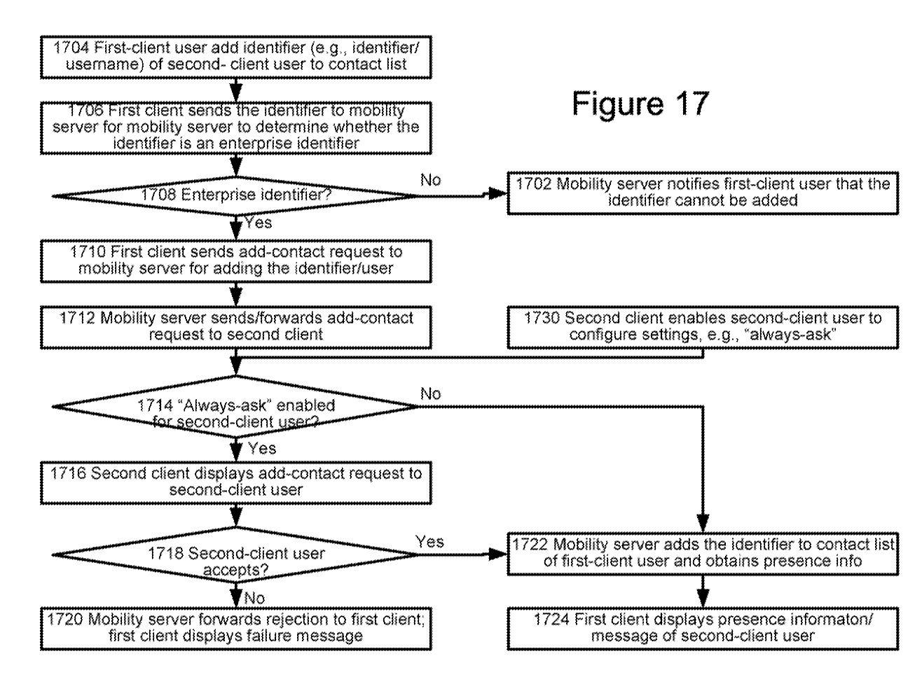

FIG. 17 shows a flowchart illustrating a method for adding a user to a contact list in accordance with one or more embodiments of the present invention. The method may start with step 1704, in which the user of a first client (e.g., client 1430 shown in the example of FIG. 14) may try to add an identifier (e.g., a number or a username) associated with a second client (e.g., client 1417 shown in the example of FIG. 14) and/or a second user to the first-client user's contact list, utilizing the user interface on the first client.

In step 1706, the first client may send the identifier to an associated mobility server (e.g., mobility server 1414 shown in the example of FIG. 14) for the mobility server or a proxy therein (e.g. proxy 1416 shown in the example of FIG. 14) to determine whether the identifier is associated with the enterprise of interest, such as the enterprise of which the first-client user is a member or the enterprise that owns the first client.

In step 1708, the mobility server (or the proxy) may determine whether the identifier is associated with the enterprise. If the identifier is not associated with the enterprise, control may be transferred to step 1702, in which, the mobility server (or the proxy) may notify the first-client user that the identifier cannot be added to the first-client user's contact list. If the identifier is associated with the enterprise, control may be transferred to step 1710.

In step 1710, the first client may send an add-contact request to the mobility server (or the proxy) for adding the identifier to the contact list. In one or more embodiments, step 1710 may not be required after step 1708. In one or more embodiment, the step of sending the add-contact request may be part of step 1706.

In step 1712, the mobility server may send or forward the add-contact request (provided by the first client) to the second client. In one or more embodiments, the mobility server may modify the request, e.g., according the needs or policies of the enterprise, before sending the request to the second client.

In step 1730, the second client may enable the second-client user to configure contact list related settings. For, example, the second client may allow the second-client user to select from options such as always-ask, conditional-ask, never-ask, etc. for defining, how the second client responds to add-contact requests.

In step 1714, the second client may determine whether the always-ask option is enabled/selected. If the always-ask option is not enabled/selected, e.g. according to the default settings, control may be transferred to step 1722; if the always-ask option not enabled/selected, control may be transferred to step 1716.

In step 1722, mobility server may add the second-client user's identifier to the first-client user's contact list and may obtain the presence state information of the second-client user. Subsequently, in step 1724, the first client may display the presence state information and/or the presence message of the second-client user.

In step 1716, the second client may display the add-contact request to the second-client user through the user interface on the second client.

In step 1718, the second client may receive input from the second-client user concerning whether the second-client user accepts or rejects the request. If the request is accepted, control may be transferred to step 1722, in which mobility server may add the second-client user's identifier to the first-client user's contact list and may obtain the presence state information of the second-client user, and then in step 1724, the first client may display the presence state information and/or the presence message of the second-client user. If the request is rejected, control may be transferred to step 1720, in which the mobility server (or the proxy) may send or forward a rejection message to the first client, accordingly, the first client may provide/display a failure message.

As can be appreciated from the example of FIG. 17, embodiments of the invention may reduce user operation in adding contacts to contact lists. The always-ask option is turned off by default such that add-contact requests are automatically accepted in a trusted enterprise environment. Advantageously, the users may not be unnecessarily disturbed by add-contact requests, and the productivity of the enterprise may be improved. Embodiments of the invention may also enable users to turn on the always-ask option for increased user control over contact lists. Advantageously, unnecessary communication may be avoided, network resource may be conserved, and enterprise productivity may also be improved.

FIG. 18 shows a flowchart illustrating a method for optimizing network resource utilization in providing presence information in accordance with one or more embodiments of the present invention.

In step 1800, the user of a client (e.g., client 1402 shown in the example of FIG. 14) or the enterprise of which the user is a member may configure settings for receiving and/or providing presence information/messages. The configuration may be performed based on considerations such as communication costs, network resource utilization, etc. For example, the receiving/providing of presence information may be configured to be automatically turned off when the client is roaming on a visited network. As another example, the user and/or the enterprise may configure the settings such that the frequency for updating presence information may be reduced (but not completely turned off) and/or the presentation/content of presence messages may be changed (e.g., with graphical elements removed) to reduce the amount of data transmitted when the client is roaming on a visited network. In one or more embodiments, the user may manually turn off the receiving/providing of presence information, change the frequency of receiving/providing presence information, or change the presentation of receiving/providing presence information, for example, during peak hours when the air-time charge is high even if the client is utilizing the home network of the client. The home network is the network with which the client is originally registered and is not be confused with the network deployed in the user's home.

In step 1802, the user or the enterprise may configure roaming settings (e.g., data roaming settings) for the client. As an example, the client may be allowed to utilize only the home network such that roaming charges may not be incurred. As another example, the client may be allowed to utilize foreign Wi-Fi and/or foreign cellular networks for data communication.

In step 1804, the client may detect that the client is within the coverage of a network, for example, utilizing information providing by one or more network elements, such as a wireless access point or a radio base station. For example, the network may be a visited foreign cellular network, a visited Wi-Fi network, or the home network.

In step 1806, the client may determine whether the receiving and/or providing for presence information is enabled, for example, based on the settings configured in step 1800. If the receiving and/or providing for presence information is not enabled, control may be transferred to step 1822, in which the client does not receive presence information from other clients and/or does not provide presence information to other clients. If the receiving and/or providing for presence information is enabled, control may be transferred to step 1808.

In step 1808, the client may determine whether data roaming is allowed for the client if the detected network is a visited network that requires roaming. If data roaming is not allowed for the client, control may be transferred to step 1824, in which the client does not receive and provide presence information, and instant messaging services are disabled for the client. If data roaming is allowed for the client, control may be transferred to step 1810.

In step 1810, the mobility server (e.g., mobility server 1414 shown in the example of FIG. 14) associated with the client or a proxy of the mobility server (e.g., proxy 1416) may check the presence information receiving/providing settings for the client, such as update frequency and/or information representation settings configured in step 1800. The mobility server (or the proxy) may handle presence information for the client according to the settings.

In step 1812, the client may provide, receive, and/or display presence info according to the settings. Instant messaging service may also be enabled for the client.

As can be appreciated from the example of FIG. 18, network resource utilization for providing presence information may be optimized, and communication costs may be reduced for the user and/or the enterprise.

As can be appreciated from the foregoing, embodiments of the invention may provide presence information concerning voice communication services. Accordingly, the costs and time required for making ineffective voice calls may be avoided. Advantageously, the cost-effectiveness for communication may be improved.

Embodiments of the invention may automate settings for presence state and messages. Embodiments of the invention may also automate settings related to contact lists. As a result, the requirements for user operation may be reduced. Advantageously, user experience, effectiveness of communication, and enterprise productivity may be improved.

Embodiments of the invention may optimize network resource utilization in providing presence information. Advantageously, network resource may be conserved, and communication costs for users and/or enterprises may be reduced.

### D. CONCLUSION

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A method for facilitating communication between at least a first user and a second user, the first user using a first device, the second user using a second device, the method comprising:
associating a plurality of possible device states with a plurality of possible presence states, the plurality of possible device states pertaining to the first device, the plurality of possible presence states pertaining to the first user;
determining a device state of the first device;
setting a communication presence state of the first user to be a first presence state if the device state is a first device state, the first presence state being one of the plurality of possible presence states, the first device state being one of the plurality of possible device states;
setting the communication presence state of the first user to be a second presence state if the device state is a second device state, the second presence state being another one of the plurality of possible presence states, the second device state being another one of the plurality of possible device states; and
providing information concerning the communication presence state of the first user to at least the second device.

2. The method of claim 1 further comprising setting the communication presence state of the first user to be a third presence state if the device state is a third device state, the third presence state being still another one of the plurality of possible presence states, the third device state being still another one of the plurality of possible device states

3. The method of claim 1 further comprising providing the information concerning the communication presence state of the first user through the second device to the second user to enable the second user to determine whether to make a voice call to the first user before making the voice call to the first user, wherein the plurality of possible presence states includes at least one of a voice-communication-only state and an on-a-call state.

4. The method of claim 1 wherein the plurality of possible presence states includes at least a voice-communication-only state, a text-communication-only state, and an available-for-both-voice-and-text-communications state.

5. The method of claim 1 wherein the plurality of possible device states includes at least a first possible device state, the first possible device state pertaining to an identifier of at least one of a network element and a network currently used by the first device.

6. The method of claim 5 wherein the plurality of possible device states further includes at least a second possible device state, the second possible device state pertaining to a calendar event stored on at least one of the first device and a server coupled with the first device.

7. The method of claim 1 wherein the plurality of possible device states includes at least a first possible device state, the first possible device state pertaining to a calendar event stored on at least one of the first device and a server coupled with the first device.

8. The method of claim 1 wherein the plurality of possible device states includes at least a first possible device state, the first possible device state pertaining to a location of the first device where the first device is disposed.

9. The method of claim 1 wherein the plurality of possible device states includes at least a first possible device state, the first possible device state pertaining to a speed of the first device at which the first device is moving.

10. The method of claim 1 wherein the plurality of possible device states includes at least a first possible device state, the first possible device state pertaining to an orientation of the first device in which the first device is disposed.

11. The method of claim 1 wherein the plurality of possible device states includes at least a first possible device state, the first possible device state pertaining to an operation mode setting of the first device, the operation mode setting pertaining to an operation environment of the first device.

12. The method of claim 1 further comprising changing the communication presence state of the first user from a first presence state to a voice-communication-only state when the first device changes from using a first network element to using a second network element.

13. The method of claim 1 further comprising changing the communication presence state of the first user from a first presence state to a text-communication-only state when the first device changes from using a first network element to using a second network element.

14. The method of claim 1 further comprising receiving input from the first user for setting a frequency for the providing.

15. The method of claim 1 further comprising changing a frequency for the providing from a first frequency to a second frequency when the first device changes from using a first network element to using a second network element.

16. The method of claim 1 further comprising receiving input from the first user for limiting a data amount of the information concerning the communication presence state of the first user.

17. The method of claim 1 further comprising:
providing the information using a first representation when the first device is using a first network element; and
providing the information using a second representation when the first device is using a second network element.

18. The method of claim 1 further comprising receiving input from the second user for setting a frequency for receiving the information concerning the communication presence state of the first user.

19. The method of claim 1 further comprising:
receiving a request from the first device for adding an identifier to the first user's contact list, the identifier associated with at least one of the second user and the second device;
determining whether the identifier is associated with an enterprise, and adding the identifier to the first user's contact list without querying the second user if the identifier is associated with the enterprise.

20. The method of claim 1 further comprising:
receiving a request from the first device for adding an identifier to the first user's contact list, the identifier associated with at least one of the second user and the second device;
receiving input from the second user regarding whether add-contact requests concerning the second user are to be considered by the second user;
determining whether the identifier is associated with an enterprise; and
adding the identifier to the first user's contact list without querying the second user if the identifier is associated with the enterprise and if the input from the second user indicates that no add-contact requests concerning the second user are to be considered by the second user.
